(19) United States
(12) Patent Application Publication
(10) Pub. No.: US 2009/0254315 A1
(43) Pub. Date: Oct. 8, 2009

(54) RESIDENTIAL DRY SPRINKLER FIRE PROTECTION SYSTEM

(75) Inventor: James E. Golinveaux, N. Kingstown, RI (US)

Correspondence Address: FOR: TYCO FIRE SUPPRESSION & BUILDING PRODUCTS;PERKINS COIE LLP, 607 Fourteenth Street, NW, Washington, DC, 20005-2003, US

(73) Assignee: TYCO FIRE PRODUCTS LP, LANSDALE, PA (US)

(21) Appl. No.: 12/417,623

(22) Filed: Apr. 2, 2009

Related U.S. Application Data
(63) Continuation-in-part of application No. 10/874,758, filed on Jun. 24, 2004.
Application No. 10/874,758 is a continuation-in-part of application No. 10/899,053, filed on Jul. 27, 2004, now abandoned.
Application No. 10/899,053 is a continuation-in-part of application No. 10/899,124, filed on Jul. 27, 2004, now abandoned.
Application No. 10/899,124 is a continuation-in-part of application No. 10/898,924, filed on Jul. 27, 2004, now abandoned.
Application No. 10/898,924 is a continuation-in-part of application No. 10/898,923, filed on Jul. 27, 2004, now abandoned.
Application No. 10/898,923 is a continuation-in-part of application No. 10/899,128, filed on Jul. 27, 2004, now abandoned.
Application No. 10/899,128 is a continuation-in-part of application No. 10/899,129, filed on Jul. 27, 2004.
Application No. 10/899,129 is a continuation-in-part of application No. 10/899,131, filed on Jul. 27, 2004, now abandoned.

(51) Int. Cl. G06F 17/50

(52) U.S. Cl. 703/1

(57) ABSTRACT

Systems and methods for residential fire protection systems in a residential dwelling unit are shown and described. The residential dwelling unit has a plurality of compartments as defined in the 2002 National Fire Protection Association Standards 13, 13D, and 13R. The methods and systems can be achieved by: determining a minimum quantity and location of residential fire sprinklers required to determine a hydraulic demand calculation of the residential fire sprinklers of a piping network filled with water and arranged to protect the plurality of compartments; and specifying the minimum quantity and location of residential fire sprinklers in a piping network filled with a gas. Various aspects of the invention are also shown and described.

### CROSS REFERENCE TO RELATED APPLICATIONS

This application is a Continuation-in-part of U.S. patent application Ser. No. 10/874,758, filed on Jun. 24, 2004, which is incorporated by reference in its entirety. This application is also a Continuation-in-part of each of U.S. patent application Ser. Nos. 10/898,923; 10/898,924; 10/899,053; 10/899,124; 10/899,128; 10/899,129; and 10/899,131, all of which were filed on Jul. 27, 2004, and the contents of which are hereby incorporated by reference in their entirety.

### BACKGROUND OF THE INVENTION

An automatic sprinkler system is one of the most widely used devices for fire protection. Such a system has sprinklers that are activated once the ambient temperature in an environment, such as a room or a building, exceeds a predetermined value. Once activated, the sprinklers distribute fire-extinguishing fluid, preferably water, in the room or building. A sprinkler system, depending on its specified configuration is considered effective if it controls or suppresses a fire. Failures of such systems may occur when the system has been rendered inoperative during building alteration or disuse, or the occupancy hazard has been increased beyond initial system capability.

The sprinkler system can be provided with a water supply (e.g., a reservoir or a municipal water supply). Such supply may be separate from that used by a fire department. Regardless of the type of supply, the sprinkler system is provided with a main that enters the building to supply a riser. Connected at the riser are valves, meters, and, preferably, an alarm to sound when water flow within the system exceeds a predetermined minimum. At the top of a vertical riser, a horizontally disposed array of pipes extends throughout the fire compartment in the building. Other risers may feed distribution networks to systems in adjacent fire compartments. Compartmentalization can divide a large building horizontally, on a single floor, and vertically, floor to floor. Thus, several sprinkler systems may serve one building.

In a piping distribution network, branch lines carry the sprinklers. A sprinkler may extend up from a branch line, placing the sprinkler relatively close to the ceiling, or a sprinkler can be pendent below the branch line. For use with concealed piping, a flush-mounted pendant residential fire sprinkler may extend only slightly below the ceiling.

The sprinkler system can be provided in various configurations. In a wet-pipe system, used for example, in buildings having heated spaces for piping branch lines, all the system pipes contain a fire-fighting fluid, such as, water for immediate release through any sprinkler that is activated. In a dry-pipe system, used for example, in unheated open areas, cold rooms, passageways, or other areas exposed to freezing, such as unheated buildings in freezing climates or for cold-storage rooms, the pipes, risers, and feed mains, disposed, branch lines and other distribution pipes of the fire protection system may contain a dry gas (air or nitrogen or mixtures thereof) under pressure. A valve is used to separate the pipes that contain a dry gas and pipes that contain a fire-fighting fluid, such as, water. In some application, the pressure of gas holds closed a dry pipe valve at the riser. When heat from a fire activates a sprinkler, the gas escapes and the dry-pipe valve trips; water enters branch lines; and fire fighting begins as the sprinkler distributes the water. By its nature, a dry sprinkler system is slower to respond to fire conditions than a wet system because the dry gas must first be exhausted from the system before the fire-fighting fluid is expelled from the fire sprinkler. Such delay creates a “water delivery time” to the sprinkler. The water delivery time introduces an additional variable for consideration in a design for fire protection with a dry pipe system.

Various standards exist for the design and installation of a fire protection system. In particular, the National Fire Protection Association (“NFPA”) describes, in its Standard for the Installation of Sprinkler Systems 13 (2002) (“the NFPA Standard 13”) various design consideration and installation parameters for a fire protection system, which standard is incorporated herein by reference in its entirety. One of many design considerations provided by NFPA Standard 13 is the quantity of fire sprinklers to be used in a fire protection system. For a wet system, the NFPA Standard 13 describes at A.14.4.4 that a quantity of fire sprinklers can be determined either by a design area calculation or by a specified quantity of sprinklers.

NFPA Standard 13 also addresses certain design considerations for dry pipe fire protection systems by modifying the design of the wet pipe system. For example, in a dry pipe system, NFPA Standard 13 states, for commercial storage (NFPA Standard 13, 12.1.6.1) and dry pipe system generally (NFPA Standard 13, 14.4.4.4.2), that a design area for a dry pipe system is to be increased 30% over the design area for the wet system in such applications so that the minimum quantity of fire sprinklers for a dry pipe system is increased by generally 30% over the same quantity of fire sprinklers in a wet system. Where Large-Drop Sprinklers are utilized in commercial fire protection, NFPA shows (at Table 12.3.2.2.1(b) and 12.3.4.2.1) that an increase in the specified quantity of sprinklers is (e.g., 50% or more) is required when a dry pipe system is utilized instead of a wet pipe for these sprinklers. When a commercial fire sprinkler is used with a dry pipe instead of a wet pipe system in dwelling applications, the design area must be increased by 30% so that the quantity of these sprinklers must be increased, and thus, the hydraulic demand is increased. It is apparent from NFPA Standard 13 that, holding all other design parameters constant, the use of a dry pipe system instead of a wet pipe system would require a relatively large increase in the quantity of fire sprinklers, which would increase the hydraulic demand of the dry pipe system.

Although NFPA Standard 13 refers in broad terms to wet pipe and dry pipe systems, NFPA Standard 13 is generally silent as to design and installation criteria for dry pipe residential sprinkler systems. For example, NFPA Standard 13 fails to specify any criteria in a design of a dry pipe residential fire sprinkler system, including a hydraulic demand calculation, the quantity of residential fire sprinklers consonant with the hydraulic demand calculation or installation constraints and use of residential fire sprinklers in a dry pipe fire protection system. In fact, NFPA Standard 13 (2002) specifically prohibits residential fire sprinklers from being used in any system other than wet unless the residential fire sprinklers are listed for such other applications, as stated in NFPA Standard 13 at 8.4.5.2:
[R]esidential sprinklers shall be used only in wet systems unless specifically listed for use in dry pipe systems or preaction systems. (Emphasis Added).

NFPA provides separate standards for design and installation of wet pipe fire protection systems in residential occupancies. These wet pipe fire protection systems may be installed with fire-resistant plastic components, such as, for example, chlorinated polyvinyl chloride (“CPVC”) pipe and fittings. Starting in 1975, NFPA provides the Standard for the Installation of Sprinkler Systems in One-And Two-Family Dwellings and Manufactured Homes 13D (“NFPA Standard 13D”). Due in part to the increasingly urbanized nature of cities, NFPA promulgated, in 1989, another standard in recognition of low-rise residential facilities, entitled Standard for the Installation of Sprinkler Systems in Residential Occupancies Up to And Including Four Stories in Height 13R (“NFPA Standard 13R”). The latest respective editions of NFPA Standard 13D and 13R are the 2002 Edition of NFPA Standard 13 and 13R, which are incorporated by reference herein in their entirety. Starting in 1988, Underwriters Laboratory (“UL”) provides for additional requirements that residential fire sprinklers must meet for residential fire protection systems as set forth in its Underwriter's Laboratory Residential fire sprinklersfor Fire-Protection Service 1626 (“UL Standard 1626”). The most recent edition of UL Standard 1626 is the October 2003 edition, which is incorporated by reference herein in its entirety.

NFPA and UL provide similar water density requirement for residential fire protection systems. NFPA Standard 13 (2002) states (Chap 11.2.3.5.2) that a density for a protection area of a residential occupancy with a generally flat ceiling as the greater of (a) 0.1 gallons per minute per square feet of the four most hydraulically demanding sprinkler over a design area or (b) a listed residential minimum density. The listed residential minimum density can be found in either NFPA Standard 13D or 13R (2020). NFPA Standard 13D (2002) states (Chapter 8.1.1.2.2 and 8.1.2) that fire sprinklers listed for residential use shall have minimum discharge density of 0.05 gallons per minute per square feet to the design sprinklers, where the quantity of design sprinklers includes all of the sprinklers, up to a maximum of two, that requires the greatest hydraulic demand, within a compartment that has generally flat and smooth ceiling. NFPA Standard 13R (2002) states (Chapter 6.7.1.1.2.2. and 6.7.1.2) that fire sprinklers listed for residential use shall have minimum discharge density of 0.05 gallons per minute per square feet to the design sprinklers, where the quantity of design sprinklers includes all of the sprinklers, up to a maximum of four, that requires the greatest hydraulic demand, within a compartment that has generally flat and smooth ceiling. UL Standard 1626 (October 2003), on the other hand, states (at Table 6.1) that the density for a coverage area with a generally flat ceiling as 0.05 gallons per minute per square feet minimum.

Although NFPA Standards 13R and 13D provide considerable flexibility in the design and installation of wet pipe residential fire protection system, these standards are strict in prohibiting any existing residential fire sprinklers that are approved for use in a wet pipe residential system from being used in any application other than a wet system. In particular, both NFPA Standard 13R and 13D (2002) reiterate the stricture stated NFPA Standard 13 (2002), which prohibits the use of residential sprinklers for systems other than wet pipe by stating, at paragraphs 6.6.7.1.2 and 7.5.2, respectively, that:
[R]esidential sprinklers shall not be used on systems other than wet pipe systems unless specifically listed for use on that particular type of system. (Emphasis Added).

While these standards may have considered a residential piping system other than a wet pipe system, e.g., a dry pipe residential system, the standards do not provide any indication of how to determine a hydraulic demand as part of a design of such systems. Furthermore, because of the guidelines in the standards regarding the use of dry pipe instead of wet pipe, those desiring to use a dry pipe sprinkler system in non-residential applications would normally increase the hydraulic demand of the dry pipe system over that of the wet pipe system, either by an increase in the design area or the quantity of sprinklers based on the wet pipe system.

Currently, it is believed that no residential fire sprinkler is approved for a dry pipe system in residential applications. Nor are fire-resistant plastic components approved for use in a dry pipe residential fire protection system. Thus, design methodologies, installation and material requirements for applications other than wet pipe fire sprinkler systems in residential applications are believed to be notably lacking.

### SUMMARY OF THE INVENTION

The present invention provides various embodiments and/or aspects of fire protection systems and various embodiments and/or aspects of methods of operating and designing such systems. In particular, provided are various embodiments of residential fire protections systems, methods of operating and designing residential fire protection systems, and methods of identifying and communicating residential fire protection information.

In one embodiment, a method of designing a dry pipe residential fire protection system in a residential dwelling unit is provided. The residential dwelling unit has a plurality of compartments as defined in the 2002 National Fire Protection Association Standards 13, 13D, and 13R. The method can be achieved by determining a minimum quantity and location of residential fire sprinklers required to determine a hydraulic demand calculation of the residential fire sprinklers of a piping network filled with water and arranged to protect the plurality of compartments. Specifying that the minimum quantity and location of residential fire sprinklers, as determined for a wet piping network, is used to determine the hydraulic demand of in a piping network filled with a gas and arranged to protect the plurality of compartments of the residential dwelling unit.

Determining the minimum quantity and location of the sprinklers preferably includes defining a magnitude of pressure and flow rate of a fluid supply source in the wet pipe fire sprinkler system, and selecting residential sprinklers at a rated K-factor appropriate for the pressure and flow rate of the fluid supply source in the wet pipe fire sprinkler system. In addition, specifying the minimum quantity and location of residential fire sprinklers preferably includes calculating the hydraulic flow rate of the selected residential fire sprinkler from the fluid supply source to the selected residential fire sprinkler to determine whether the selected fire sprinkler, up to a maximum of two, within a compartment of the residential dwelling unit, requires the highest hydraulic flow rate.

Alternatively or in addition to, specifying the minimum quantity and location of residential fire sprinklers preferably includes calculating the hydraulic flow rate of the selected residential fire sprinkler from the fluid supply source to the selected residential fire sprinkler to determine whether the selected fire sprinkler, up to a maximum of four, within a compartment of the residential dwelling unit, requires the highest hydraulic flow rate.

In another aspect of the method of designing, specifying the minimum quantity and location of the sprinklers preferably includes selecting residential fire sprinklers at a nominal rated K-factor of nominal 4 or 5, and more preferably selected from a group of rated K-factors consisting of 3.0, 3.9, 4.1, 4.2, 4.3, 4.4, 4.7, 4.9, 5.5, and 5.6. Moreover, the flow of water, measured in gallons per minute, is preferably selected from a group of flow rates consisting of 12, 13, 14, 16, 17, 18, 19, 20, 21, 23, 24, 25, 26, 27, and 28 gallons per minute.

Another method of designing a dry pipe residential fire protection system in a residential dwelling unit is provided. The residential dwelling unit has a plurality of compartments as defined in the 2002 National Fire Protection Association Standards 13D. The method preferably includes determining a minimum number of residential fire sprinklers based on a hydraulic demand calculation of all residential fire sprinklers up to two sprinklers within a compartment of the residential dwelling unit for a wet pipe fire sprinkler system, and specifying the minimum quantity and location of residential fire sprinklers, as determined, in a residential fire sprinkler piping system filled with a gas to protect the plurality of compartments for installation accordance with NFPA 13D. The system preferably includes: (a) a water supply source to provide sufficient water flow rate to a network of pipes so as to maintain a preselected density for a predetermined duration; (b) a single control valve; (c) a dry pipe valve; and (d) a network of pipes to be filled with a gas when the residential sprinklers are in an unactuated condition so that the pipes are dry.

Yet another method of designing a dry pipe residential fire protection system in a residential dwelling unit is provided. The residential dwelling unit has a plurality of compartments as defined in the 2002 National Fire Protection Association Standards 13 and 13R, and the method preferably includes: determining a minimum number of residential fire sprinklers based on a hydraulic demand calculation of all residential fire sprinklers up to four sprinklers within a compartment of the residential dwelling unit for a wet pipe fire sprinkler system, and specifying the minimum quantity and location of residential fire sprinklers, as determined, in a residential fire sprinkler piping system filled with a gas to protect the plurality of compartments for installation accordance with NFPA 13R. The system preferably includes: (a) a water supply source to provide sufficient water flow rate to a network of pipes so as to maintain a preselected density for a predetermined duration; (b) a single control valve; (c) a dry pipe valve; and (d) a network of pipes to be filled with a gas when the residential sprinklers are in an unactuated condition so that the pipes are dry.

In aspect of the methods of designing, specifying the quantity and location of the residential sprinklers preferably includes identifying: at least one type of residential fire sprinkler to be used in the dwelling unit; a plurality of protection areas to be protected by the at least one type of residential fire sprinkler in the dwelling unit, each of the plurality of protection areas having a dimension of X by Y, wherein X is any value from 10 feet to 20 feet and Y is any value from 10 feet to 24 feet; and a plurality of minimum flow rates and residual pressures for a respective one of a plurality of protection areas.

In another aspect of the methods, identifying a plurality of protection areas preferably provides that the plurality of protection areas are related to at least one of the following: (a) spacing between any two of the at least one type of residential fire sprinklers; (b) a type of ceiling over a protection area; (c) rated K-factor of the at least one type of residential fire sprinkler; (d) minimum flow rate per sprinkler; (e) pressure of fluid being supplied to the at least one type of residential fire sprinkler; and (f) temperature at which the at least one type of residential fire sprinkler activates. In another aspect, the plurality of protection areas further preferably include a protection area for at least one of a generally flat, sloped or beamed ceiling, and the protection area further preferably includes at least one of 144 square feet; 196 square feet; 256 square feet; 288 square feet; 320 square feet; or 400 square feet.

According to another preferred aspect of the method, identifying at least one type of residential fire sprinklers preferably includes identifying a fire sprinkler selected from a group consisting of one of a pendant sprinkler having a rated K-factor of 5, a sidewall sprinkler having a rated K-factor of 4, and combinations thereof.

In another aspect of the method of designing, identifying a plurality of minimum flow rates preferably provides a plurality of flow rates for a pendent type sprinkler with a rated K-factor of 4.9 when connected to at least one dry pipe of the network of pipes in one of the plurality of design protection areas having a horizontal ceiling with a maximum rise of two inches per foot of run, the plurality of flow rates including about 15 gallons per minute for a protected area of about 144, 196, or 256 square feet; about 17 gallons per minute for a protected area of about 324 square feet; or about 20 gallons per minute for a protected area of about 400 square feet.

In another aspect of the method of designing, identifying a plurality of minimum flow rates preferably provides a plurality of flow rates for a sidewall type sprinkler with a rated K-factor of 4.2 when connected to at least one dry pipe of the network of pipes in one of the plurality of protected areas, the plurality of flow rates including about at least 12 gallons per minute for a protected area of about 144 square feet; about at least 16 gallons per minute for a protected area of about 196 or 256 square feet; about at least 19 gallons per minute for a protected area of about 288 square feet; or about at least 23 gallons per minute for a protected area of about 320 square feet.

In yet another aspect of the method of designing, identifying a plurality of minimum flow rates preferably provides a plurality of flow rates for a pendent type sprinkler with a rated K-factor of 4.2 when connected to at least one dry pipe of the network of pipes in one of the plurality of design protection areas having a horizontal ceiling with a maximum rise of two inches per foot of run, the plurality of flow rates including about 13 gallons per minute for a protected area of about 144, 196, or 256 square feet; about 18 gallons per minute for a protected area of about 324 square feet; or about 22 gallons per minute for a protected area of about 400 square feet.

In another aspect of the method of designing identifying a plurality of minimum flow rates preferably provides a plurality of flow rates for a pendent type sprinkler with a rated K-factor of 4.2 when connected to at least one dry pipe of the network of pipes in one of the plurality of design protection areas having a sloped ceiling with a maximum rise of eight inches per foot of run, the plurality of flow rates including about 17 gallons per minute for a protected area of about 144, 196, or 256 square feet; about 19 gallons per minute for a protected area of about 324 square feet; or about 24 gallons per minute for a protected area of about 400 square feet.

In yet another aspect of the method of designing, identifying a plurality of minimum flow rates preferably provides a plurality of flow rates for two pendent type sprinklers each with a rated K-factor of 4.2 when connected to respective dry pipes of the network of pipes in one of the plurality of design protection areas having a sloped ceiling with a maximum rise of eight inches per foot of run, the plurality of flow rates including about 14 gallons per minute for a protected area of about 144, 196, or 256 square feet; or about 18 gallons per minute for a protected area of about 324 square feet.

In another aspect of the preferred method of designing, the method preferably includes calculating a hydraulic demand providing a density of at least 0.1 gallons per minute per square foot. Alternatively or in addition to, the calculating provides a density of at least 0.05 gallons per minute per square foot for each of the minimum quantity of residential fire sprinklers.

In another embodiment, a residential dwelling unit fire protection system is provided. The residential dwelling unit has a plurality of compartments as defined in the 2002 National Fire Protection Association Standard 13D. The system includes a supply of pressurized fluid, a network of pipes, a quantity of residential fire sprinklers. The supply of pressurized fluid is located proximate the dwelling unit. The network of pipes is in fluid communication with the fluid supply, and the network of pipes includes at least one pipe extending over each of the compartments. The at least one pipe is filled generally with a gas so that the at least one pipe is dry. The quantity of residential fire sprinklers is located adjacent each of the compartments, and each of the quantity of residential fire sprinklers is coupled to the at least one pipe filled with a gas so that, upon actuation of at least one fire sprinkler of the quantity of residential fire sprinklers, fluid is delivered from fluid supply to the compartments within a first time period. And, the quantity of residential fire sprinkler is based on a calculated hydraulic demand for all residential fire sprinklers, up to two sprinklers, having the highest calculated demand within a compartment.

Another preferred residential dwelling unit fire protection system is provided. In the preferred system, the residential dwelling unit has a plurality of compartments as defined in the 2002 National Fire Protection Association Standards 13 and 13R. The system preferably includes a supply of pressurized fluid, a network of pipes, a quantity of residential fire sprinklers. The system includes a supply of pressurized fluid, a network of pipes, a quantity of residential fire sprinklers. The supply of pressurized fluid is preferably located proximate the dwelling unit. The network of pipes is in fluid communication with the fluid supply, and the network of pipes includes at least one pipe extending over each of the compartments. The at least one pipe is filled generally with a gas so that the at least one pipe is dry. The quantity of residential fire sprinklers are located adjacent each of the compartments, and each of the quantity of residential fire sprinklers is coupled to the at least one pipe filled with a gas so that, upon actuation of at least one fire sprinkler of the quantity of residential fire sprinklers, fluid is delivered from fluid supply to the compartments within a first time period. And, the quantity of residential fire sprinkler is based on a calculated hydraulic demand for all residential fire sprinklers, up to four sprinklers, having the highest calculated demand within a compartment. In any of the preferred residential unit fire protection systems, first time period is preferably about 10 seconds and more preferably about 15 seconds.

In another embodiment, a method of communicating fire protection information for a residential dwelling unit as defined in the 2002 National Fire Protection Association Standards 13, 13D, and 13R is provided. The method includes identifying residential fire protection information and directing a user to design a residential fire protection system with the information. The identification includes: at least one type of fire sprinkler for each of the plurality of protected areas including a rated K-factor for the fire sprinkler; a plurality of areas to be protected in the dwelling unit, each of the plurality of design protection areas having a dimension of X by Y, wherein X is any value from 10 feet to 20 feet and Y is any value from 10 feet to 24 feet; and a plurality of minimum flow rates and residual pressures for a respective plurality of areas. The information is applicable to both wet and dry pipe residential fire sprinkler networks so that a user is directed to a design a residential fire protection system with the same number of the at least one fire sprinkler in one of wet or dry pipe system in a dwelling unit based on the identification of fire protection information.

In one aspect, identifying the fire protection information preferably includes protection areas in relation to at least one of the following: (a) type of ceiling over the design protection area; (b) spacing between any two of the at least one type of residential fire sprinklers; (c) rated K-factor of the at least one type of residential fire sprinkler from nominally 4 to 6; (d) minimum flow rate per sprinkler; (e) pressure of fluid being supplied to the at least one type of residential fire sprinkler; and (f) temperature at which the at least one type of residential fire sprinkler activates.

In another aspect of the method, identifying the fire protection information preferably provides a plurality of protection areas that includes a protection area for at least one of a generally flat, sloped or beamed ceiling, and the protection area includes at least one of 144 square feet; 196 square feet; 256 square feet; 288 square feet; 320 square feet; or 400 square feet.

In yet another aspect of the method, identifying the at least one residential fire sprinkler preferably includes identifying a plurality of rated K-factors including nominally 4 and 5, and more preferably identifying at least one type of residential fire sprinkler selected from a group consisting of one of residential pendant sprinkler having a rated K-factor of 5, sidewall sprinkler having a rated K-factor of 4, and combinations thereof.

Alternatively, or in addition to, the identifying of fire protection information preferably includes identifying a plurality of flow rates for a residential pendent type sprinkler with a rated K-factor of 4.9 when connected to at least one dry pipe of the network of pipes in one of the plurality of design protection areas having a horizontal ceiling with a maximum rise of two inches per foot of run, the plurality of flow rates including about 15 gallons per minute for a protected area of about 144, 196, or 256 square feet; about 17 gallons per minute for a protected area of about 324 square feet; or about 20 gallons per minute for a protected area of about 400 square feet.

Identifying the information, can alternatively include identifying the minimum flow rate having a plurality of flow rates for a residential sidewall type sprinkler with a rated K-factor of 4.2 when connected to at least one dry pipe of the network of pipes in one of the plurality of protected areas, the plurality of flow rates including about at least 12 gallons per minute for a protected area of about 144 square feet; about at least 16 gallons per minute for a protected area of about 196 or 256 square feet; about at least 19 gallons per minute for a protected area of about 288 square feet; or about at least 23 gallons per minute for a protected area of about 320 square feet.

In yet another aspect of the preferred method, the identifying of fire protection information can include identifying the minimum flow rate having a plurality of flow rates for a residential pendent type sprinkler with a rated K-factor of 4.2 when connected to at least one dry pipe of the network of pipes in one of the plurality of design protection areas having a horizontal ceiling with a maximum rise of two inches per foot of run, the plurality of flow rates including about 13 gallons per minute for a protected area of about 144, 196, or 256 square feet; about 18 gallons per minute for a protected area of about 324 square feet; or about 22 gallons per minute for a protected area of about 400 square feet.

In yet another aspect of the preferred method, the identifying of fire protection information can include identifying the minimum flow rate having a plurality of flow rates for a residential pendent type sprinkler with a rated K-factor of 4.2 when connected to at least one dry pipe of the network of pipes in one of the plurality of design protection areas having a sloped ceiling with a maximum rise of eight inches per foot of run, the plurality of flow rates including about 17 gallons per minute for a protected area of about 144, 196, or 256 square feet; about 19 gallons per minute for a protected area of about 324 square feet; or about 24 gallons per minute for a protected area of about 400 square feet.

In yet another aspect of the preferred method, identifying of fire protection information preferably includes identifying the minimum flow rate having a plurality of flow rates for two residential pendent type sprinklers each with a rated K-factor of 4.2 when connected to respective dry pipes of the network of pipes in one of the plurality of design protection areas having a sloped ceiling with a maximum rise of eight inches per foot of run, the plurality of flow rates including about 14 gallons per minute for a protected area of about 144, 196, or 256 square feet; or about 18 gallons per minute for a protected area of about 324 square feet.

Another residential dwelling unit fire protection system for a residential dwelling unit is provided. The residential dwelling unit has a plurality of compartments as defined in the 2002 National Fire Protection Association Standards 13, 13D, and 13R. The fire protection system includes a pressurized liquid supply, a pressurized gas supply, a control valve coupled to the liquid and gas supplies, the control valve being biased in a closed position to prevent liquid flow through the control valve based on a pressure differential between the liquid and gas supplies, a network of pipes coupled to the pressurized gas supply, a quantity of residential fire sprinklers, and an alarm coupled to the network of pipes to provide an indication of liquid flow through the network of pipes. The network of pipes includes at least one pipe extending over each of the compartments. The at least one pipe is filled generally with a gas from the pressurized gas supply so that the at least one pipe is dry. The quantity of residential fire sprinklers are located adjacent each of the compartments. Each of the quantity of residential fire sprinklers is coupled to the at least one pipe so that, upon actuation of at least one residential fire sprinkler, the control valve is actuated to deliver liquid from the liquid supply to at least one of the residential fire sprinklers for distribution over a protection area at a predetermined density in at least one compartment, an alarm coupled to the network of pipes to provide an indication of liquid flow through the network of pipes.

In one aspect of the system, the quantity of residential fire sprinklers is preferably determined based on a hydraulic demand calculation of all residential fire sprinklers up to four residential fire sprinklers within a compartment of the residential dwelling unit for a wet pipe fire sprinkler system. In another aspect of the preferred systems, the liquid is delivered to the at least one of the residential fire sprinklers within a first time period that elapses from the actuation of the at least one residential fire sprinkler preferably in about 10 seconds, and more preferably in about 15 seconds.

In another preferred aspect of the system, the residential fire sprinkler includes a residential pendant type fire sprinkler with a rated K-factor of at least nominally 4. More preferably, the residential fire sprinkler includes a residential sidewall sprinkler having a rated K-factor of at least nominally 4. In another preferred aspect of the system, the control valve is a dry pipe valve having an inlet and an outlet each with an opening of about two inches in diameter, and the system further includes a sensor coupled to the at least one pipe to detect the presence of liquid in the at least one pipe and provide an alarm upon detection of liquid in the at least one pipe. For the system, the predetermined density is preferably at least 0.1 gallons per minute per square foot, and is more preferably at least 0.05 gallons per minute per square feet.

Another preferred method of operating a residential fire protection system in a residential dwelling unit is also provided. The residential dwelling unit has a plurality of compartments as defined in the 2002 National Fire Protection Association Standards 13, 13D, and 13 R. The residential fire protection system includes a pressurized liquid supply, a pressurized gas supply, a control valve coupled to the liquid and gas supplies and biased in a closed position to prevent liquid flow through the control valve based on a pressure differential between the liquid and gas supplies, a network of pipes coupled to the pressurized gas supply, and a minimum quantity of residential fire sprinklers based on a hydraulic demand calculation of all residential fire sprinklers up to four residential fire sprinklers within each compartment of the residential dwelling unit. The network of pipes includes at least one pipe extending over each of the compartments. The at least one pipe is filled generally with a gas from the pressurized gas supply so that the at least one pipe is dry. The method can be achieved by expelling the gas from the at least one pipe upon actuation of at least one residential fire sprinkler in fluid communication with the at least one pipe; flowing liquid through the network to the at least one residential fire sprinkler for distribution over a protection area in a compartment of the residential dwelling unit; and indicating the flow of liquid through the network of pipes. The preferred method further includes signaling the actuation of the at least one residential fire sprinkler.

In another aspect of the method of operating the system, the flowing includes delivering liquid to the at least one residential fire sprinkler within a time period that elapses from the actuation of the at least one fire sprinkler, and more preferably, the time period ranges from about 10 seconds or about 15 seconds. In another preferred aspect, the flowing comprises delivering a flow of water in gallons per minute selected from a group of flow rates consisting of 12, 13, 14, 16, 17, 18, 19, 20, 21, 23, 24, 25, 26, 27, and 28 gallons per minute. The flowing further preferably includes delivering a density of at least 0.1 gallons per minute per square feet, and more preferably delivering a density of at least 0.05 gallons per minute per square foot. Moreover, the at least one type of residential fire sprinklers preferably includes a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another preferred method of designing a dry pipe residential fire protection system in a residential dwelling unit is provided. The residential dwelling unit has a plurality of compartments as defined in the 2002 National Fire Protection Association Standards 13, 13D, and 13R. The method can be achieved by determining a minimum quantity or number of residential fire sprinklers based on a hydraulic demand calculation of all residential fire sprinklers up to four residential fire sprinklers within a compartment of the residential dwelling unit; specifying the quantity and location of residential fire sprinklers, as determined, in a residential fire sprinkler piping system filled with a gas to protect the plurality of compartments for installation in accordance with NFPA 13D and 13R; and specifying an indicator of liquid flow through the residential fire sprinkler system. The system includes a liquid supply source, a gas supply source, a control valve coupled to the liquid and gas supplies, a network of pipes coupled to the control valve and the pressurized gas supply, and the network of pipes includes at least one pipe extending over each of the compartments. The control valve is biased in a closed position to prevent liquid flow through the control valve based on a pressure differential between the liquid and gas supplies. The at least one pipe is filled generally with a gas from the pressurized gas supply so that the at least one pipe is dry.

In one aspect of the method of designing, determining a minimum quantity of residential fire sprinklers preferably includes defining a magnitude of pressure and flow rate of a fluid supply source in a wet pipe fire sprinkler system, and selecting residential sprinklers at a rated K-factor appropriate for the pressure and flow rate of the fluid supply source in the wet pipe fire sprinkler system.

In another aspect of the method of designing, specifying the quantity and location of residential fire sprinklers preferably includes calculating the hydraulic flow rate of the selected residential fire sprinkler from the fluid supply source to the selected residential fire sprinkler to determine whether the selected fire sprinkler, up to a maximum of two, within a compartment of the residential dwelling unit, requires the highest hydraulic flow rate. Alternatively, the specifying includes calculating the hydraulic flow rate of the selected residential fire sprinkler from the fluid supply source to the selected residential fire sprinkler to determine whether the selected fire sprinkler, up to a maximum of four, within a compartment of the residential dwelling unit, requires the highest hydraulic flow rate.

In a further aspect of the method of designing, specifying the quantity and location of residential fire sprinklers includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6. The method of designing further preferably provides that defining the magnitude of flow rate of the fluid includes defining the flow of water in gallons per minute selected from a group of flow rates consisting of 12, 13, 14, 16, 17, 18, 19, 20, 21, 23, 24, 25, 26, 27, and 28 gallons per minute.

In one preferred aspect of the method of designing, selecting the residential sprinklers provides that a residential fire sprinkler is selected from a group consisting of one of a pendent or flush-pendent residential fire sprinkler having a rated K-factor of 5, a sidewall residential fire sprinkler having a rated K-factor of 4, and combinations thereof.

In another aspect of the method of designing, determining the minimum quantity of residential sprinklers based on a hydraulic demand calculation provides a density of at least 0.1 gallons per minute per square foot, and more preferably, the calculating comprises providing a density of at least 0.05 gallons per minute per square feet to each of the quantity of residential fire sprinklers.

Another residential dwelling unit fire protection system for a residential dwelling unit is provided. The residential dwelling unit has a plurality of compartments as defined in the 2002 National Fire Protection Association Standards 13, 13D, and 13R. The fire protection system includes a pressurized liquid supply, a pressurized gas supply, a control valve coupled to the liquid and gas supplies, a network of pipes coupled to the control valve and the pressurized gas supply, a pressure sensor coupled to at least one pipe, an alarm coupled to the pressure sensor, and a quantity of residential fire sprinklers located adjacent each of the compartments. The control valve is normally in a closed position when unactuated to prevent liquid flow through the control valve. The network of pipes includes at least one pipe extending over each of the compartments, and at least one pipe is filled generally with a gas from the pressurized gas supply so that the at least one pipe is dry. The pressure sensor senses the pressure of the gas in the at least one pipe and provides a signal to actuate the control valve towards an open position when gas pressure in the at least one pipe is below a predetermined threshold. The alarm provides a signal to indicate the reduction of gas pressure in the network of pipes. Each of the quantity of residential fire sprinklers is coupled to the at least one pipe so that, upon a reduction in gas pressure in the at least one pipe, the control valve is actuated by the pressure sensor to deliver liquid from the liquid supply to at least one of the residential fire sprinklers for distribution over a protection area at a predetermined density in at least one compartment.

In a preferred aspect of the system, the quantity of residential fire sprinklers is determined based on a hydraulic demand calculation of all residential fire sprinklers up to four residential fire sprinklers within a compartment of the residential dwelling unit for a wet pipe fire sprinkler system. Moreover, the liquid is delivered to the at least one of the residential fire sprinklers within a first time period that elapses from the actuation of the at least one residential fire sprinkler preferably in about 10 seconds, and more preferably in about 15 seconds.

In another aspect of the preferred system the residential fire sprinkler includes a residential pendant type fire sprinkler having a rated K-factor of at least nominally 4, and additionally, the residential fire sprinkler includes a residential sidewall sprinkler having a rated K-factor of at least nominally 4. The preferred system further provides that the control valve includes a solenoid actuated valve having an inlet and an outlet coupled respectively to the liquid supply and the network of pipes. More preferably, the solenoid actuated valve includes an solenoid actuated valve having an inlet and an outlet each with an opening of less than two inches in diameter.

In another aspect, the preferred system preferably includes a releasing control panel responsive to the signal provided by the pressure sensor to electrically energize the solenoid actuated valve and the alarm. In a further aspect of the system, each of the quantity of residential sprinklers comprises a density of at least 0.1 gallons per minute per square feet, and more preferably provides a predetermined density comprises at least 0.05 gallons per minute per square feet.

Another method of operating a residential fire protection system in a residential dwelling unit is provided. The residential dwelling unit has a plurality of compartments as defined in the 2002 National Fire Protection Association Standards 13, 13D5 and 13R. The residential fire protection system includes a pressurized liquid supply, a pressurized gas supply, a control valve coupled to the liquid and gas supplies and normally closed to prevent liquid flow through the control valve, a network of pipes coupled to the control valve and the pressurized gas supply, and a minimum quantity of residential fire sprinklers based on a hydraulic demand calculation of all residential fire sprinklers up to four residential fire sprinklers within each compartment of the residential dwelling unit. The network of pipes includes at least one pipe extending over each of the compartments. The at least one pipe is filled generally with a gas from the pressurized gas supply so that the at least one pipe is dry. The method can be achieved by sensing a reduction of gas pressure in the at least one pipe; flowing liquid from the liquid supply via the control valve through the network pipes to the at least one residential fire sprinkler for distribution over a protection area in a compartment of the residential dwelling unit; and indicating the reduction in the gas pressure in the network of pipes to a magnitude below a threshold value.

In one preferred aspect of the method of operating the system, indicating the reduction in gas pressure includes signaling the reduction in the gas pressure with an alarm device. In addition, flowing liquid from the liquid supply includes delivering liquid to the at least one residential fire sprinkler within a time period that elapses from the actuation of the at least one fire sprinkler. Preferably, the time period is a time period of about 10 seconds or about 15 seconds.

In another aspect of operating the system, flowing the liquid preferably includes delivering a flow of water in gallons per minute selected from a group of flow rates consisting of 12, 13, 14, 16, 17, 18, 19, 20, 21, 23, 24, 25, 26, 27, and 28 gallons per minute. In addition, the flowing preferably includes delivering a density of at least 0.1 gallons per minute per square feet, and more preferably includes delivering a density of at least 0.05 gallons per minute per square foot. Preferably, the at least one type of residential fire sprinklers includes a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another method of designing a dry pipe residential fire protection system in a residential dwelling unit is provided. The residential dwelling unit has a plurality of compartments as defined in the 2002 National Fire Protection Association Standards 13, 13D5 and 13R. The system includes a liquid supply source, a gas supply source, a control valve coupled to the liquid and gas supplies, a network of pipes coupled to the control valve and the pressurized gas supply. The network of pipes includes at least one pipe extending over each of the compartments. The system includes a releasing control panel to actuate the control valve to an open position that permits liquid to flow through the control valve to the network of pipes and the residential fire sprinklers. The control valve is configured in a normally-closed position to prevent liquid flow through the control valve. The at least one pipe is filled generally with a gas from the pressurized gas supply so that the at least one pipe is dry. The method can be achieved by determining a minimum quantity of residential fire sprinklers based on a hydraulic demand calculation of all residential fire sprinklers up to four residential fire sprinklers within a compartment of the residential dwelling unit; specifying the quantity and location of residential fire sprinklers, as determined, in a residential fire sprinkler piping system filled with a gas to protect the plurality of compartments for installation accordance with NFPA 13D and 13R; and specifying a device to indicate a reduction in the gas pressure in the network to the releasing control panel.

In one preferred aspect of the method of designing, determining the minimum quantity of residential fire sprinklers based on a hydraulic demand calculation includes defining a magnitude of pressure and flow rate of a fluid supply source in a wet pipe fire sprinkler system, and selecting residential sprinklers at a rated K-factor appropriate for the pressure and flow rate of the fluid supply source in the wet pipe fire sprinkler system.

In another preferred aspect of the method of designing, specifying the quantity and location of the residential fire sprinklers includes calculating the hydraulic flow rate of the selected residential fire sprinkler from the fluid supply source to the selected residential fire sprinkler to determine whether the selected fire sprinkler, up to a maximum of two, within a compartment of the residential dwelling unit, requires the highest hydraulic flow rate. Alternatively, the specifying includes calculating the hydraulic flow rate of the selected residential fire sprinkler from the fluid supply source to the selected residential fire sprinkler to determine whether the selected fire sprinkler, up to a maximum of four, within a compartment of the residential dwelling unit, requires the highest hydraulic flow rate.

In yet another preferred aspect of the method of designing, specifying the quantity and location of the residential fire sprinklers includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6. Alternatively, the at least one type of residential fire sprinklers comprises a residential fire sprinkler selected from a group consisting of one of a pendent or flush-pendent residential fire sprinkler having a rated K-factor of 5, a sidewall residential fire sprinkler having a rated K-factor of 4, and combinations thereof. Moreover, the method of designing preferably provides that the flow of water comprises a flow of water in gallons per minute selected from a group of flow rates consisting of 12, 13, 14, 16, 17, 18, 19, 20, 21, 23, 24, 25, 26, 27, and 28 gallons per minute. In the method of designing, the hydraulic demand calculation preferably provides a density of at least 0.1 gallons per minute per square feet, and more preferably provides a density of at least 0.05 gallons per minute per square feet to each of the minimum quantity of residential fire sprinklers.

Another residential dwelling unit fire protection system for a residential dwelling unit is provided. The residential dwelling unit has a plurality of compartments as defined in the 2002 National Fire Protection Association Standards 13, 13D, and 13R. The fire protection system includes a pressurized liquid supply, a pressurized gas supply, a control valve coupled to the liquid and gas supplies, a network of pipes coupled to the control valve with at least one pipe, a minimum quantity of residential fire sprinklers, a pressure sensor coupled to the at least one pipe to sense the pressure of the gas in the at least one pipe or the network, a fire detection device disposed proximate the residential dwelling unit, and a releasing control panel coupled to the pressure sensor and the fire detection device. The control valve is normally in a closed position when unactuated to prevent liquid flow through the control valve. The network of pipes includes at least one pipe extending over each of the compartments. The at least one pipe is filled generally with a gas from the pressurized gas supply so that the at least one pipe is dry. The pressure sensor provides a signal to indicate when gas pressure in the at least one pipe is below a predetermined threshold. The fire detection device detects a fire in the dwelling unit. The alarm is coupled to the releasing control panel so that an alarm is provided when the control valve is actuated to an open position. The quantity of residential fire sprinklers is located adjacent each of the compartments. Each of the quantity of residential fire sprinklers is coupled to the at least one pipe so that, upon at least one of a reduction in the gas pressure in the at least one pipe or a fire proximate the residential dwelling unit, the control valve is actuated by the releasing control panel to deliver liquid from the liquid supply to at least one of the residential fire sprinklers for distribution over a protection area at a predetermined density in at least one compartment.

In one preferred aspect of the preferred residential unit fire protection system, the minimum quantity of residential fire sprinklers is determined based on a hydraulic demand calculation of all residential fire sprinklers up to four residential fire sprinklers within a compartment of the residential dwelling unit for a wet pipe fire sprinkler system. In another preferred aspect of the system, the liquid is delivered to the at least one of the residential fire sprinklers within a first time period that elapses from the actuation of the at least one residential fire sprinkler in about 10 seconds, and more preferably in about 15 seconds.

In yet another aspect of the preferred system, the residential fire sprinkler includes a residential pendant type fire sprinkler having a rated K-factor of at least nominally 4, and more preferably includes a residential sidewall sprinkler having a rated K-factor of at least nominally 4. In a further aspect of the system, the control valve includes a solenoid actuated valve having an inlet and an outlet coupled respectively to the liquid supply and the network of pipes. More preferably, the solenoid actuated valve is a solenoid actuated valve having an inlet and an outlet each with an opening of less than two inches in diameter. In another preferred aspect, the system provides that the releasing control panel is responsive to the signal provided by the pressure sensor to electrically energize the solenoid actuated valve and the alarm. The residential dwelling unit fire protection system also preferably provides that the predetermined density is at least 0.1 gallons per minute per square feet, and more preferably at least 0.05 gallons per minute per square feet.

Another method of operating a residential fire protection system in a residential dwelling unit is provided. The residential dwelling unit has a plurality of compartments as defined in the 2002 National Fire Protection Association Standards 13, 13D, and 13R. The residential fire protection system includes a pressurized liquid supply, a pressurized gas supply, a control valve coupled to the liquid and gas supplies and normally closed to prevent liquid flow through the control valve, a network of pipes coupled to the control valve and the pressurized gas supply, and a minimum quantity of residential fire sprinklers based on a hydraulic demand calculation of all residential fire sprinklers up to four residential fire sprinklers within each compartment of the residential dwelling unit. The network of pipes includes at least one pipe extending over each of the compartments. The at least one pipe is filled generally with a gas from the pressurized gas supply so that the at least one pipe is dry. The method can be achieved by sensing a reduction of gas pressure in the at least one pipe or a fire proximate the residential dwelling unit; flowing liquid from the liquid supply via the control valve through the network pipes to the at least one residential fire sprinkler for distribution over a protection area in a compartment of the residential dwelling unit; and indicating the reduction in the gas pressure in the network of pipes to a magnitude below a threshold value or a fire proximate the dwelling unit.

In one aspect of operating the system, indicating the reduction in gas pressure preferably includes signaling the reduction in the gas pressure or the fire with an alarm device. The method of operation also preferably provides that flowing liquid from the liquid supply includes delivering liquid to the at least one residential fire sprinkler within a time period that elapses from the actuation of the at least one fire sprinkler preferably in about 10 seconds or about 15 seconds. Moreover, the method of operating the residential fire protection system provides delivering a flow of water in gallons per minute selected from a group of flow rates consisting of 12, 13, 14, 16, 17, 18, 19, 20, 21, 23, 24, 25, 26, 27, and 28 gallons per minute. Preferably, flowing the liquid includes delivering a density of at least 0.1 gallons per minute per square feet, and more preferably a density of at least 0.05 gallons per minute per square feet.

In yet another aspect of operating the residential system, the at least one type of residential fire sprinklers includes a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another method of designing a dry pipe residential fire protection system in a residential dwelling unit is provided. The residential dwelling unit has a plurality of compartments as defined in the 2002 National Fire Protection Association Standards 13, 13D, and 13R. The method can be achieved by determining a minimum quantity of residential fire sprinklers based on a hydraulic demand calculation of all residential fire sprinklers up to four residential fire sprinklers within a compartment of the residential dwelling unit; specifying the quantity and location of residential fire sprinklers, as determined, in a residential fire sprinkler piping system filled with a gas to protect the plurality of compartments for installation accordance with NFPA 13D and 13R; and specifying a device to provide a signal to a releasing panel that indicates at least one of reduction in gas pressure in the at least one pipe or a fire proximate the dwelling unit. The system includes a liquid supply source, a gas supply source, a control valve, a network of pipes, and a releasing control panel. The control valve is coupled to the liquid supply and configured in a normally closed position to prevent liquid flow through the control valve. The network of pipes is coupled to the control valve and the pressurized gas supply and includes at least one pipe that extends over each of the compartments. The at least one pipe is filled generally with a gas from the pressurized gas supply so that the at least one pipe is dry. The releasing control panel is responsive to sensed signals to actuate the control valve to an open position that permits liquid to flow through the control valve to the network of pipes and the residential fire sprinklers.

In one aspect of the method of designing the residential system, determining the minimum quantity of residential fire sprinklers based on a hydraulic demand calculation preferably includes defining a magnitude of pressure and flow rate of a fluid supply source in a wet pipe fire sprinkler system, and selecting residential sprinklers at a rated K-factor appropriate for the pressure and flow rate of the fluid supply source in the wet pipe fire sprinkler system.

In another aspect of the method, specifying the quantity and location of residential fire sprinklers preferably includes calculating the hydraulic flow rate of the selected residential fire sprinkler from the fluid supply source to the selected residential fire sprinkler to determine whether the selected fire sprinkler, up to a maximum of two, within a compartment of the residential dwelling unit, requires the highest hydraulic flow rate. Alternatively, the specifying includes calculating the hydraulic flow rate of the selected residential fire sprinkler from the fluid supply source to the selected residential fire sprinkler to determine whether the selected fire sprinkler, up to a maximum of four, within a compartment of the residential dwelling unit, requires the highest hydraulic flow rate. The method of designing further preferably provides that specifying the quantity and location of residential fire sprinklers includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6. In calculating the hydraulic flow rate, the flow preferably includes a flow of water in gallons per minute selected from a group of flow rates consisting of 12, 13, 14, 16, 17, 18, 19, 20, 21, 23, 24, 25, 26, 27, and 28 gallons per minute. Preferably, the calculation provides a density of at least 0.1 gallons per minute per square foot, and more preferably at least 0.05 gallons per minute per square foot.

In another aspect of the preferred method of designing, selecting residential sprinklers preferably provides that the at least one type of residential fire sprinklers includes a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another residential dwelling unit fire protection system for a residential dwelling unit is provided. The residential dwelling unit has a plurality of compartments as defined in the 2002 National Fire Protection Association Standards 13, 13D, and 13R. The fire protection system includes a pressurized liquid supply, a pressurized gas supply, a control valve coupled to the liquid and gas supplies, a network of pipes coupled to the control valve with at least one pipe, a quantity of residential fire sprinklers, a pressure sensor coupled to the at least one pipe to sense the pressure of the gas in the at least one pipe, a fire detection device disposed proximate the residential dwelling unit, and a releasing control panel coupled to the pressure sensor and the fire detection device. The alarm device is configured to indicate a fire or fault in the system. At least one of the quantity of residential fire sprinklers being coupled to the at least one pipe. The control valve is normally in a closed position when unactuated to prevent liquid flow through the control valve. The network of pipes includes at least one pipe extending over each of the compartments. The at least one pipe is filled generally with a gas from the pressurized gas supply so that the at least one pipe is dry. The pressure sensor provides a signal to indicate when gas pressure in the at least one pipe or the network of pipes is below a predetermined threshold. The fire detection device detects a fire in the dwelling unit and outputs a signal of the fire. The releasing control panel is coupled to the pressure sensor and the fire detection device so that the releasing control panel actuates the alarm device to indicate a fault in the system when the pressure sensor detects gas pressure in the at least one pipe or the network is below a predetermined threshold without a receipt of the signal provided by the fire detection device. The releasing control panel also actuates the control valve to an open position when the fire detection device detects a fire.

In one aspect of the residential dwelling unit fire protection system, the quantity of residential fire sprinklers is determined based on a hydraulic demand calculation of all residential fire sprinklers up to four residential fire sprinklers within a compartment of the residential dwelling unit for a wet pipe fire sprinkler system. In another aspect, the liquid is preferably delivered to the at least one of the residential fire sprinklers within a first time period that elapses from the actuation of the at least one residential fire sprinkler in about 10 seconds, and preferably about 15 seconds. The residential fire sprinkler of the system preferably includes a residential pendant type fire sprinkler having a rated K-factor of at least nominally 4, and alternatively or in addition to, the residential fire sprinkler includes a residential sidewall sprinkler having a rated K-factor of at least nominally 4. In yet another aspect of the system, the control valve includes a solenoid actuated valve having an inlet and an outlet coupled respectively to the liquid supply and the network of pipes. Preferably, the solenoid actuated valve includes a solenoid actuated valve having an inlet and an outlet, each with an opening of less than two inches in diameter. In another aspect of the residential dwellling unit fire protection system, the releasing control panel preferably actuates the control valve to an open position when the fire detection device detects a fire prior to the actuation of any residential fire sprinkler. Upon actuation of the control valve, the system preferably provides for a predetermined density of at least 0.1 gallons per minute per square foot, and more preferably at least 0.05 gallons per minute per square foot.

Another method of operating a residential fire protection system in a residential dwelling unit is provided. The residential dwelling unit has a plurality of compartments as defined in the 2002 National Fire Protection Association Standards 13, 13D, and 13R. The residential fire protection system includes a pressurized liquid supply, a pressurized gas supply, a control valve coupled to the liquid and gas supplies and normally closed to prevent liquid flow through the control valve, a network of pipes coupled to the control valve and the pressurized gas supply, and a quantity of residential fire sprinklers based on a hydraulic demand calculation of all residential fire sprinklers up to four residential fire sprinklers within each compartment of the residential dwelling unit. The network of pipes includes at least one pipe extending over each of the compartments. The at least one pipe is filled generally with a gas from the pressurized gas supply so that the at least one pipe is dry. The method can be achieved by sensing a reduction of gas pressure in the at least one pipe or network of pipes; indicating a fault in the fire system when the gas pressure in the network of pipes is below a threshold value in the absence of a fire proximate the residential dwelling unit; sensing a fire proximate the residential dwelling unit; flowing liquid from the liquid supply via the control valve through the network pipes to the at least one residential fire sprinkler for distribution over a protection area in a compartment of the residential dwelling unit when the fire is sensed; and indicating a flow of liquid from the control valve through the network of pipes.

In one aspect of the method of operating the system, indicating a flow of liquid from the control valve preferably includes signaling the occurrence of a fire. In another aspect of flowing liquid, comprises flowing liquid prior to the actuation of any residential fire sprinkler. The flowing preferably includes delivering liquid to the at least one residential fire sprinkler within a time period that elapses from the actuation of the at least one residential fire sprinkler. The time period is preferably about 10 seconds or about 15 seconds. Flowing the liquid from the liquid supply, in another aspect of the method, preferably includes delivering a flow of water in gallons per minute selected from a group of flow rates consisting of 12, 13, 14, 16, 17, 18, 19, 20, 21, 23, 24, 25, 26, 27, and 28 gallons per minute. Preferably, flowing the liquid includes delivering a density of at least 0.1 gallons per minute per square foot, and more preferably delivering a density of at least 0.05 gallons per minute per square foot.

In one aspect of the method of operating the system, the at least one type of residential fire sprinklers includes a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another method of designing a dry pipe residential fire protection system in a residential dwelling unit is provided. The residential dwelling unit has a plurality of compartments as defined in the 2002 National Fire Protection Association Standards 13, 13D, and 13R. The system includes a liquid supply source, a gas supply source, a control valve, a network of pipes, a pressure sensor coupled to the network of pipes to sense gas pressure in the network of pipes, a fire detection device disposed proximate the dwelling unit to detect a fire, an alarm device, and a releasing control panel to actuate the control valve to an open position that permits liquid to flow through the control valve to the network of pipes and the residential fire sprinklers. The releasing control panel is coupled to the alarm device, pressure sensor, and the fire detection device. The control valve is coupled to the liquid supply and configured in a normally closed position to prevent liquid flow through the control valve. The network of pipes is coupled to the control valve and the pressurized gas supply and includes at least one pipe that extends over each of the compartments. The at least one pipe is filled generally with a gas from the pressurized gas supply so that the at least one pipe is dry. The method can be achieved by: determining a quantity of residential fire sprinklers based on a hydraulic demand calculation of all residential fire sprinklers up to four residential fire sprinklers within a compartment of the residential dwelling unit; specifying the quantity and location of residential fire sprinklers, as determined, in a residential fire sprinkler piping system filled with a gas to protect the plurality of compartments for installation accordance with NFPA 13D and 13R; and specifying the releasing control panel to activate the alarm to indicate a fault in the system when the pressure sensor senses gas pressure below a threshold value in the absence of a detection of a fire by the fire detection device and activates the alarm and control valve to an open position prior to actuation of the at least one residential fire sprinkler when the fire detection device detects a fire.

In one aspect of the method of designing, the determining includes defining a magnitude of pressure and flow rate of a fluid supply source in a wet pipe fire sprinkler system, and selecting residential sprinklers at a rated K-factor appropriate for the pressure and flow rate of the fluid supply source in the wet pipe fire sprinkler system.

In another aspect of the method, specifying the quantity includes calculating the hydraulic flow rate of the selected residential fire sprinkler from the fluid supply source to the selected residential fire sprinkler to determine whether the selected fire sprinkler, up to a maximum of two, within a compartment of the residential dwelling unit, requires the highest hydraulic flow rate. Alternatively, specifying of the quantity includes calculating the hydraulic flow rate of the selected residential fire sprinkler from the fluid supply source to the selected residential fire sprinkler to determine whether the selected fire sprinkler, up to a maximum of four, within a compartment of the residential dwelling unit, requires the highest hydraulic flow rate. In one preferred aspect of specifying, the calculating preferably includes providing a density of at least 0.1 gallons per minute per square foot, and more preferably includes providing a density of at least 0.05 gallons per minute per square foot.

In another aspect of the method of designing, specifying of the quantity includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6. Preferably, the method provides a flow of water in gallons per minute selected from a group of flow rates consisting of 12, 13, 14, 16, 17, 18, 19, 20, 21, 23, 24, 25, 26, 27, and 28 gallons per minute.

In another aspect of the method of designing, at least one type of residential fire sprinklers comprises a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another residential dwelling unit fire protection system for a residential dwelling unit is provided. The residential dwelling unit has a plurality of compartments as defined in the 2002 National Fire Protection Association Standards 13, 13D, and 13R. The fire protection system includes a pressurized liquid supply, a pressurized gas supply, a control valve coupled to the liquid and gas supplies, a network of pipes coupled to the control valve with at least one pipe, a quantity of residential fire sprinklers, a pressure sensor coupled to the at least one pipe to sense the pressure of the gas in the at least one pipe, a fire detection device disposed proximate the residential dwelling unit, and a releasing control panel coupled to the pressure sensor and the fire detection device. The alarm device is configured to indicate a fire or fault in the system. At least one of the quantity of residential fire sprinklers being coupled to the at least one pipe. The control valve is normally in a closed position when unactuated to prevent liquid flow through the control valve. The network of pipes includes at least one pipe extending over each of the compartments. The at least one pipe is filled generally with a gas from the pressurized gas supply so that the at least one pipe is dry. The pressure sensor provides a signal to indicate when gas pressure in the at least one pipe or the network of pipes is below a predetermined threshold. The fire detection device detects a fire in the dwelling unit and outputs a signal of the fire. The releasing control panel is coupled to the pressure sensor and the fire detection device so that the releasing control panel actuates the alarm device to indicate a fault in the system when the pressure sensor detects gas pressure in the at least one pipe or the network is below a predetermined threshold without a receipt of the signal provided by the fire detection device. The releasing control panel also actuates the control valve to an open position upon a receipt of output signals from the fire detection device and pressure sensor.

In one aspect of the system, the quantity of residential fire sprinklers is determined based on a hydraulic demand calculation of all residential fire sprinklers up to four residential fire sprinklers within a compartment of the residential dwelling unit for a wet pipe fire sprinkler system. In another aspect of the system the liquid is delivered to the at least one of the residential fire sprinklers within a first time period that elapses from the actuation of the at least one residential fire sprinkler preferably in about 10 seconds, and more preferably in about 15 seconds. In yet another aspect of the system, the residential fire sprinkler includes a residential pendant type fire sprinkler having a rated K-factor of at least nominally 4, and more preferably includes a residential sidewall sprinkler having a rated K-factor of at least nominally 4. In another aspect of residential dwelling unit fire protection system, the control valve includes a solenoid actuated valve having an inlet and an outlet coupled respectively to the liquid supply and the network of pipes, the solenoid valve being actuated upon a receipt of output signals from the fire detection device and pressure sensor prior to the actuation of at least one residential fire sprinkler. Preferably, the solenoid actuated valve includes an solenoid actuated valve having an inlet and an outlet, each with an opening of less than two inches in diameter. Preferably, the system provides for a predetermined density of at least 0.1 gallons per minute per square feet, and more preferably a predetermined density comprises at least 0.05 gallons per minute per square feet.

Another method of operating a residential fire protection system in a residential dwelling unit is provided. The residential dwelling unit has a plurality of compartments as defined in the 2002 National Fire Protection Association Standards 13, 13D, and 13R. The residential fire protection system includes a pressurized liquid supply, a pressurized gas supply, a control valve coupled to the liquid and gas supplies and normally closed to prevent liquid flow through the control valve, a network of pipes coupled to the control valve and the pressurized gas supply, and a quantity of residential fire sprinklers based on a hydraulic demand calculation of all residential fire sprinklers up to four residential fire sprinklers within each compartment of the residential dwelling unit. The network of pipes includes at least one pipe extending over each of the compartments. The at least one pipe is filled generally with a gas from the pressurized gas supply so that the at least one pipe is dry. The method can be achieved by sensing a reduction of gas pressure in the at least one pipe or network of pipes; indicating a fault in the fire system when the gas pressure in the network of pipes is below a threshold value in the absence of a fire proximate the residential dwelling unit; sensing a fire proximate the residential dwelling unit; flowing liquid from the liquid supply via the control valve through the network pipes to the at least one residential fire sprinkler for distribution over a protection area in a compartment of the residential dwelling unit when a fire and a reduction in gas pressure are sensed; and indicating a flow of liquid from the control valve through the network of pipes.

In one aspect of the method of operating the system, indicating a flow of liquid from the control valve includes signaling the occurrence of a fire. In yet another aspect of the method, flowing liquid from the liquid supply preferably includes flowing liquid prior to the actuation of any residential fire sprinkler. The flowing of liquid further preferably includes delivering liquid to the at least one residential fire sprinkler within a time period that elapses from the actuation of the at least one residential fire sprinkler. The time period preferably being about 10 seconds or about 15 seconds.

In another aspect of the method of operating, flowing liquid from the liquid supply preferably includes delivering a flow of water in gallons per minute selected from a group of flow rates consisting of 12, 13, 14, 16, 17, 18, 19, 20, 21, 23, 24, 25, 26, 27, and 28 gallons per minute. The flowing liquid preferably delivers a density of at least 0.1 gallons per minute per square foot, and more preferably includes delivering a density of at least 0.05 gallons per minute per square foot.

In yet another aspect of the method of operating, the at least one type of residential fire sprinklers includes a residential fire sprinkler selected from a group consisting of one of a pendent or flush-pendent residential fire sprinkler having a rated K-factor of 5, a sidewall residential fire sprinkler having a rated K-factor of 4, and combinations thereof.

Another method of designing a dry pipe residential fire protection system in a residential dwelling unit is provided. The residential dwelling unit has a plurality of compartments as defined in the 2002 National Fire Protection Association Standards 13, 13D, and 13R. The system includes a liquid supply source, a gas supply source, a control valve, a network of pipes, a pressure sensor coupled to the network of pipes to sense gas pressure in the network of pipes, a fire detection device disposed proximate the dwelling unit to detect a fire, an alarm device, and a releasing control panel to actuate the control valve to an open position that permits liquid to flow through the control valve to the network of pipes and the residential fire sprinklers. The releasing control panel is coupled to the alarm device, pressure sensor, and the fire detection device. The control valve is coupled to the liquid supply and configured in a normally closed position to prevent liquid flow through the control valve. The network of pipes is coupled to the control valve and the pressurized gas supply and includes at least one pipe that extends over each of the compartments. The at least one pipe is filled generally with a gas from the pressurized gas supply so that the at least one pipe is dry. The method can be achieved by: determining a quantity of residential fire sprinklers based on a hydraulic demand calculation of all residential fire sprinklers up to four residential fire sprinklers within a compartment of the residential dwelling unit; specifying the quantity and location of residential fire sprinklers, as determined, in a residential fire sprinkler piping system filled with a gas to protect the plurality of compartments for installation accordance with NFPA 13D and 13R; and specifying the releasing control panel to activate the alarm to indicate a fault in the system when the pressure sensor senses gas pressure below a threshold value in the absence of a detection of a fire by the fire detection device and activates the alarm and control valve to an open position upon a receipt of output signals from the fire detection device and pressure sensor.

In one aspect of the method of designing, the determining includes defining a magnitude of pressure and flow rate of a fluid supply source in a wet pipe fire sprinkler system, and selecting residential sprinklers at a rated K-factor appropriate for the pressure and flow rate of the fluid supply source in the wet pipe fire sprinkler system. In another aspect of the method specifying of the quantity of the residential sprinklers preferably includes calculating the hydraulic flow rate of the selected residential fire sprinkler from the fluid supply source to the selected residential fire sprinkler to determine whether the selected fire sprinkler, up to a maximum of two, within a compartment of the residential dwelling unit, requires the highest hydraulic flow rate. Alternatively, the specifying of the quantity of sprinklers includes calculating the hydraulic flow rate of the selected residential fire sprinkler from the fluid supply source to the selected residential fire sprinkler to determine whether the selected fire sprinkler, up to a maximum of four, within a compartment of the residential dwelling unit, requires the highest hydraulic flow rate. Additionally, the method of designing preferably provides that the specifying of the quantity of residential sprinklers includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6. Moreover, the method provides determining the flow rate preferably includes a flow of water in gallons per minute selected from a group of flow rates consisting of 12, 13, 14, 16, 17, 18, 19, 20, 21, 23, 24, 25, 26, 27, and 28 gallons per minute. In one aspect of the method of designing, specifying the quantity of the residential sprinklers preferably includes calculating the hydraulic flow rate providing a density of at least 0.1 gallons per minute per square foot, and more preferably providing a density of at least 0.05 gallons per minute per square foot.

In yet another aspect of the method of designing, the at least one type of residential fire sprinklers includes a residential fire sprinkler selected from a group consisting of one of a pendent or flush-pendent residential fire sprinkler having a rated K-factor of 5, a sidewall residential fire sprinkler having a rated K-factor of 4, and combinations thereof. Moreover, in the method of designing, specifying the releasing control pane, preferably includess indicating that the alarm and control valve are actuated upon a receipt of output signals from the fire detection device and pressure sensor prior to actuation of the at least one residential fire sprinkler.

A method of designing a dry pipe residential fire protection system in a residential dwelling unit that utilizes fire-resistant plastic components is provided. The residential dwelling unit has a plurality of compartments as defined in the 2002 National Fire Protection Association Standards 13, 13D, and 13R. The method can be achieved by specifying a quantity and location of residential fire sprinklers to determine the hydraulic demand of a piping network filled with a gas and arranged to protect the plurality of compartments of the residential dwelling unit; and specifying at least one component of the dry pipe residential fire sprinkler piping network as a fire-resistant plastic component.

In one aspect of the method of designing, specifying the quantity and location of the residential sprinkler preferably includes defining a magnitude of pressure and flow rate of a liquid supply source in a wet pipe fire sprinkler system, and selecting residential sprinklers at a rated K-factor appropriate for the pressure and flow rate of the liquid supply source in the wet pipe fire sprinkler system. In another aspect of the method, specifying the quantity of the sprinklers includes calculating the hydraulic flow rate of the selected residential fire sprinkler from the liquid supply source to the selected residential fire sprinkler to determine whether the selected fire sprinkler, up to a maximum of two, within a compartment of the residential dwelling unit, requires the highest hydraulic flow rate. Alternatively, specifying the quantity includes calculating the hydraulic flow rate of the selected residential fire sprinkler from the liquid supply source to the selected residential fire sprinkler to determine whether the selected fire sprinkler, up to a maximum of four, within a compartment of the residential dwelling unit, requires the highest hydraulic flow rate. Specifying the quantity of residential sprinklers further preferably includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6. In another aspect of the method of designing, defining the flow rate of a liquid preferably provides for a flow of water in gallons per minute selected from a group of flow rates consisting of 12, 13, 14, 16, 17, 18, 19, 20, 21, 23, 24, 25, 26, 27, and 28 gallons per minute. In yet another aspect of the method of designing, specifying the at least one component of the piping network, preferably includes indicating chlorinated polyvinyl chloride plastic pipes and fittings.

Another method of designing a dry pipe residential fire protection system in a residential dwelling unit that has a plurality of compartments as defined in the 2002 National Fire Protection Association Standards 13D is provided. The method can be achieved by determining a quantity of residential fire sprinklers based on a hydraulic demand calculation of all residential fire sprinklers up to two sprinklers within a compartment of the residential dwelling unit; and specifying the quantity and location of residential fire sprinklers, as determined, in a residential fire sprinkler piping system filled with a gas to protect the plurality of compartments for installation accordance with NFPA 13D. The system includes: (a) a liquid supply source to provide sufficient liquid flow rate to a network of pipes so as to maintain a preselected density for a predetermined duration; (b) a gas supply source to provide pressurized gas; (c) a control valve coupled to the liquid supply and the gas supply; and (d) a network of fire-resistant plastic pipes and fire-resistant plastic fittings coupled to the control valve and to the quantity of residential fire sprinklers, the network of fire-resistant plastic pipes and fire-resistant plastic fittings being filled with a gas from the gas supply source so that the pipes are dry when the control valve is in a closed position that prevents liquid from flowing through the control valve to the residential fire sprinklers.

Yet another method of designing a dry pipe residential fire protection system in a residential dwelling unit that has a plurality of compartments as defined in the 2002 National Fire Protection Association Standards 13D is provided. The method can be achieved by determining a quantity of residential fire sprinklers based on a hydraulic demand calculation of all residential fire sprinklers up to four residential fire sprinklers within a compartment of the residential dwelling unit; and specifying the quantity and location of residential fire sprinklers, as determined, in a residential fire sprinkler piping system filled with a gas to protect the plurality of compartments for installation accordance with NFPA 13R, The system includes: (a) a liquid supply source to provide sufficient liquid flow rate to a network of pipes so as to maintain a preselected density for a predetermined duration; (b) a gas supply source to provide pressurized gas; (c) a control valve coupled to the liquid supply and the gas supply; and (d) a network of fire-resistant plastic pipes and fire-resistant plastic fittings coupled to the control valve and to the quantity of residential fire sprinklers, the network of fire-resistant plastic pipes and fire-resistant plastic fittings being filled with a gas from the gas supply source so that the pipes are dry when the control valve is in a closed position that prevents liquid from flowing through the control valve to the residential fire sprinklers.

In one aspect of the methods of designing a dry pipe residential fire protection system, specifying the quantity and location of the residential sprinklers preferably includes identifying: at least one type of residential fire sprinkler to be used in the dwelling unit; a plurality of protection areas to be protected by the at least one type of residential fire sprinkler in the dwelling unit, each of the plurality of protection areas having a dimension of X by Y, wherein X is any value from 10 feet to 20 feet and Y is any value from 10 feet to 24 feet; and a plurality of minimum flow rates and residual pressures for a respective one of a plurality of protection areas.

In another aspect of the methods of designing, system preferably provides that the fire-resistant plastic components comprise chlorinated polyvinyl chloride pipes and fittings. Moreover, the plurality of protection areas of the system are preferably related to at least one of the following: (a) spacing between any two of the at least one type of residential fire sprinklers; (b) a type of ceiling over a protection area; (c) rated K-factor of the at least one type of residential fire sprinkler; (d) minimum flow rate per sprinkler; (e) pressure of liquid being supplied to the at least one type of residential fire sprinkler; and (f) temperature at which the at least one type of residential fire sprinkler activates.

In yet another aspect of the designing a dry pipe residential fire protection system, the system preferably provides that the plurality of protection areas include a protection area for at least one of a generally flat, sloped or beamed ceiling, and in which the protection area includes at least one of 144 square feet; 196 square feet; 256 square feet; 288 square feet; 320 square feet; or 400 square feet.

The methods of designing and the determining the quantity of residential fire sprinklers preferably provides that the rated K-factor of the sprinkler provide a plurality of rated K-factors including nominal K-factors of 4 and 5. In one aspect of the methods, specifying the quantity of residential sprinklers further preferably includes selecting from a group consisting of one of a pendent or flush-pendent residential fire sprinkler having a rated K-factor of 5, a sidewall residential fire sprinkler having a rated K-factor of 4, and combinations thereof.

In another aspect of the methods of designing a dry pipe residential fire protection system, identifying a plurality of minimum flow rates preferably provides a plurality of flow rates for a pendent type sprinkler with a rated K-factor of 4.9 when connected to at least one dry pipe of the network of pipes in one of the plurality of design protection areas having a horizontal ceiling with a maximum rise of two inches per foot of run, the plurality of flow rates including about 15 gallons per minute for a protected area of about 144, 196, or 256 square feet; about 17 gallons per minute for a protected area of about 324 square feet; or about 20 gallons per minute for a protected area of about 400 square feet.

In another aspect of the methods of designing a dry pipe residential fire protection system, identifying a plurality of minimum flow rates preferably provides a plurality of flow rates for a sidewall type sprinkler with a rated K-factor of 4.2 when connected to at least one dry pipe of the network of pipes in one of the plurality of protected areas, the plurality of flow rates including about at least 12 gallons per minute for a protected area of about 144 square feet; about at least 16 gallons per minute for a protected area of about 196 or 256 square feet; about at least 19 gallons per minute for a protected area of about 288 square feet; or about at least 23 gallons per minute for a protected area of about 320 square feet.

In another aspect of the methods of designing a dry pipe residential fire protection system, identifying a plurality of minimum flow rates preferably provides a plurality of flow rates for a pendent type sprinkler with a rated K-factor of 4.2 when connected to at least one dry pipe of the network of pipes in one of the plurality of design protection areas having a horizontal ceiling with a maximum rise of two inches per foot of run, the plurality of flow rates including about 13 gallons per minute for a protected area of about 144, 196, or 256 square feet; about 18 gallons per minute for a protected area of about 324 square feet; or about 22 gallons per minute for a protected area of about 400 square feet.

In another aspect of the methods of designing a dry pipe residential fire protection system, identifying a plurality of minimum flow rates preferably provides a plurality of flow rates for a pendent type sprinkler with a rated K-factor of 4.2 when connected to at least one dry pipe of the network of pipes in one of the plurality of design protection areas having a sloped ceiling with a maximum rise of eight inches per foot of run, the plurality of flow rates including about 17 gallons per minute for a protected area of about 144, 196, or 256 square feet; about 19 gallons per minute for a protected area of about 324 square feet; or about 24 gallons per minute for a protected area of about 400 square feet.

In another aspect of the methods of designing a dry pipe residential fire protection system, identifying a plurality of minimum flow rates preferably provides a plurality of flow rates for two pendent type sprinklers each with a rated K-factor of 4.2 when connected to respective dry pipes of the network of pipes in one of the plurality of design protection areas having a sloped ceiling with a maximum rise of eight inches per foot of run, the plurality of flow rates including about 14 gallons per minute for a protected area of about 144, 196, or 256 square feet; or about 18 gallons per minute for a protected area of about 324 square feet.

In another aspect of the methods of designing a dry pipe residential fire protection system, identifying a plurality of minimum flow rates preferably provides for calculating a density of at least 0.1 gallons per minute per square foot, and more preferably, calculating a density of at least 0.05 gallons per minute per square foot.

Another fire protection system residential dwelling unit fire protection system is provided. The residential dwelling unit has a plurality of compartments as defined in the 2002 National Fire Protection Association Standard 13D. The system includes a supply of pressurized liquid, a supply of pressurized gas, a control valve coupled to the liquid and gas supplies, a network of pipes in fluid communication with the control valve and the gas supply, and a quantity of residential fire sprinklers located adjacent each of the compartments. The control valve is configured to occlude flow of liquid through the control valve. The network of pipes includes at least one fire-resistant plastic pipe extending over each of the compartments. The at least one fire-resistant plastic pipe is filled generally with a gas so that the at least one fire-resistant plastic pipe is dry. Each of the quantity of residential fire sprinklers being coupled to the at least one fire-resistant plastic pipe filled with a gas so that, upon actuation of at least one fire sprinkler of the quantity of residential fire sprinklers, gas is expelled and liquid is delivered from liquid supply to the compartments within a first time period. And the quantity of residential fire sprinkler is based on a calculated hydraulic demand for all residential fire sprinklers, up to two sprinklers, having the highest calculated demand within a compartment.

Yet another fire protection system residential dwelling unit fire protection system is provided. The residential dwelling unit has a plurality of compartments as defined in the 2002 National Fire Protection Association Standard 13R. The system includes a supply of pressurized liquid, a supply of pressurized gas, a control valve coupled to the liquid and gas supplies, a network of pipes in fluid communication with the control valve and the gas supply, and a quantity of residential fire sprinklers located adjacent each of the compartments. The control valve is configured to occlude flow of liquid through the control valve. The network of pipes includes at least one fire-resistant plastic pipe extending over each of the compartments. The at least one fire-resistant plastic pipe is filled generally with a gas so that the at least one fire-resistant plastic pipe is dry. Each of the quantity of residential fire sprinklers being coupled to the at least one fire-resistant plastic pipe filled with a gas so that, upon actuation of at least one fire sprinkler of the quantity of residential fire sprinklers, gas is expelled and liquid is delivered from liquid supply to the compartments within a first time period. And, the quantity of residential fire sprinkler is based on a calculated hydraulic demand for all residential fire sprinklers, up to four residential fire sprinklers, having the highest calculated demand within a compartment.

In one aspect of the residential dwelling unit fire protection systems, the first time period is about 10 seconds, and more preferably about 15 seconds. In another aspect of the residential fire protection systems, the residential fire sprinkler includes a residential pendant type fire sprinkler having a rated K-factor of at least nominally 4 and more preferably includes a residential sidewall sprinkler having a rated K-factor of at least nominally 4. In yet another aspect of the residential dwelling unit fire protection systems, the at least one fire-resistant plastic pipe preferably includes chlorinated polyvinyl chloride plastic pipes and fittings.

Another method of designing a dry pipe residential fire protection system in a residential dwelling unit that utilizes fire-resistant plastic components is provided. The residential dwelling unit has a plurality of compartments as defined in the 2002 National Fire Protection Association Standards 13, 13D, and 13R. The method can be achieved by specifying a quantity and location of residential fire sprinklers in a residential fire sprinkler piping network having a main pipe a branch pipe connected to the residential fire sprinklers filled with a gas to protect the plurality of compartments; and specifying the branch pipe as a fire-resistant plastic branch pipe with an opening having a cross-sectional area different than the cross-sectional area of the main pipe.

In one aspect of the method of designing the residential fire protection system, specifying the quantity and location of the sprinklers preferably includes defining a magnitude of pressure and flow rate of a liquid supply source in a wet pipe fire sprinkler system; and selecting residential sprinklers at a rated K-factor appropriate for the pressure and flow rate of the liquid supply source in the wet pipe fire sprinkler system. In another aspect of the method of designing, specifying the branch pipe preferably includes specifying a fire-resistant plastic main pipe having a cross-sectional area greater than the cross-sectional area of the branch pipe.

Another aspect of the method of designing preferably provides that the specifying the quantity includes calculating the hydraulic flow rate of the selected residential fire sprinkler from the liquid supply source to the selected residential fire sprinkler to determine whether the selected fire sprinkler, up to a maximum of two, within a compartment of the residential dwelling unit, requires the highest hydraulic flow rate. Alternatively, the specifying the quantity includes calculating the hydraulic flow rate of the selected residential fire sprinkler from the liquid supply source to the selected residential fire sprinkler to determine whether the selected fire sprinkler, up to a maximum of four, within a compartment of the residential dwelling unit, requires the highest hydraulic flow rate. In yet another aspect of the method, specifying the quantity of residential sprinklers preferably includes selecting residential fire sprinklers at a nominal rated K-factor selected from a group of rated K-factors consisting of 3.0, 3.9, 4.1, 4.2, 4.3, 4.4, 4.7, 4.9, 5.5, and 5.6, and specifying the branch pipe preferably includes indicating chlorinated polyvinyl chloride plastic pipes and fittings. Specifying the quantity of residential fire sprinklers further preferably provides a flow of water in gallons per minute selected from a group of flow rates consisting of 12, 13, 14, 16, 17, 18, 19, 20, 21, 23, 24, 25, 26, 27, and 28 gallons per minute.

Another method of designing a dry pipe residential fire protection system in a residential dwelling unit that has a plurality of compartments as defined in the 2002 National Fire Protection Association Standards 13D is provided. The method can be achieved by determining a quantity of residential fire sprinklers based on a hydraulic demand calculation of all residential fire sprinklers up to two sprinklers within a compartment of the residential dwelling unit; and specifying the quantity and location of residential fire sprinklers, as determined, in a residential fire sprinkler piping system with a branch pipe filled with a gas to protect the plurality of compartments for installation accordance with NFPA 13D. The system includes: (a) a liquid supply source to provide sufficient liquid flow rate to a network of pipes so as to maintain a preselected density for a predetermined duration; (b) a gas supply source to provide pressurized gas; (c) a network of a main pipe and a branch pipe, the branch pipe including a fire-resistant plastic branch pipe and fire-resistant plastic fitting coupled to the control valve and to the quantity of residential fire sprinklers, the main pipe having an internal opening being filled with liquid with a cross-sectional area different than the cross-sectional area of the internal opening of the branch pipe, the fire-resistant plastic branch pipe and fire-resistant plastic fittings being filled with a gas from the gas supply source; and (d) a control valve disposed between the main pipe and the branch pipe, the control valve coupled to the liquid supply and the gas supply so that the main pipe is wet with liquid and the branch pipe is dry when the control valve is in a closed position that prevents liquid from flowing through the control valve to the residential fire sprinklers.

Yet another method of designing a dry pipe residential fire protection system in a residential dwelling unit that has a plurality of compartments as defined in the 2002 National Fire Protection Association Standards 13D is provided. The method can be achieved by determining a quantity of residential fire sprinklers based on a hydraulic demand calculation of all residential fire sprinklers up to four residential fire sprinklers within a compartment of the residential dwelling unit; and specifying the quantity and location of residential fire sprinklers, as determined, in a residential fire sprinkler piping system with a branch pipe filled with a gas to protect the plurality of compartments for installation accordance with NFPA 13D. The system includes: (a) a liquid supply source to provide sufficient liquid flow rate to a network of pipes so as to maintain a preselected density for a predetermined duration; (b) a gas supply source to provide pressurized gas; (c) a network of a main pipe and a branch pipe, the branch pipe including a fire-resistant plastic branch pipe and fire-resistant plastic fitting coupled to the control valve and to the quantity of residential fire sprinklers, the main pipe having an internal opening being filled with liquid with a cross-sectional area different than the cross-sectional area of the internal opening of the branch pipe, the fire-resistant plastic branch pipe and fire-resistant plastic fittings being filled with a gas from the gas supply source; and (d) a control valve disposed between the main pipe and the branch pipe, the control valve coupled to the liquid supply and the gas supply so that the main pipe is wet with liquid and the branch pipe is dry when the control valve is in a closed position that prevents liquid from flowing through the control valve to the residential fire sprinklers.

In one aspect of the methods of designing, specifying the quantity of the residential fire sprinklers preferably includes identifying: at least one type of residential fire sprinkler to be used in the dwelling unit; a plurality of protection areas to be protected by the at least one type of residential fire sprinkler in the dwelling unit, each of the plurality of protection areas having a dimension of X by Y, wherein X is any value from 10 feet to 20 feet and Y is any value from 10 feet to 24 feet; and a plurality of minimum flow rates and residual pressures for a respective one of a plurality of protection areas. In the methods of designing a dry pipe residential fire protection system, the system preferably provides that the fire-resistant plastic components include chlorinated polyvinyl chloride pipes and fittings. Moreover, the method of designing preferably provides that the plurality of protection areas are related to at least one of the following: (a) spacing between any two of the at least one type of residential fire sprinklers; (b) a type of ceiling over a protection area; (c) rated K-factor of the at least one type of residential fire sprinkler; (d) minimum flow rate per sprinkler; (e) pressure of liquid being supplied to the at least one type of residential fire sprinkler; and (f) temperature at which the at least one type of residential fire sprinkler activates.

In one aspect of the methods of designing the fire protection system, the plurality of protection areas preferably provide a protection area for at least one of a generally flat, sloped or beamed ceiling, and the protection area includes at least one of 144 square feet; 196 square feet; 256 square feet; 288 square feet; 320 square feet; or 400 square feet. The methods further preferably provides that the rated K-factor comprises a plurality of rated K-factors including nominal K-factors of 4 and 5. Alternatively or in addition to, the methods preferably provide that the at least one type of residential fire sprinklers comprises a residential fire sprinkler selected from a group consisting of one of a pendent or flush-pendent residential fire sprinkler having a rated K-factor of 5, a sidewall residential fire sprinkler having a rated K-factor of 4, and combinations thereof.

In another aspect of the methods of designing the residential fire protection system, the system preferably provides that the minimum flow rate per sprinkler include a plurality of flow rates for a pendent type sprinkler with a rated K-factor of 4.9 when connected to at least one dry pipe of the network of pipes in one of the plurality of design protection areas having a horizontal ceiling with a maximum rise of two inches per foot of run, the plurality of flow rates including about 15 gallons per minute for a protected area of about 144, 196, or 256 square feet; about 17 gallons per minute for a protected area of about 324 square feet; or about 20 gallons per minute for a protected area of about 400 square feet.

In another aspect of the methods of designing the residential fire protection system, the system preferably provides that the minimum flow rate per sprinkler include a plurality of flow rates for a sidewall type sprinkler with a rated K-factor of 4.2 when connected to at least one dry pipe of the network of pipes in one of the plurality of protected areas, the plurality of flow rates including about at least 12 gallons per minute for a protected area of about 144 square feet; about at least 16 gallons per minute for a protected area of about 196 or 256 square feet; about at least 19 gallons per minute for a protected area of about 288 square feet; or about at least 23 gallons per minute for a protected area of about 320 square feet.

In yet another aspect of the methods of designing the residential fire protection system, the system preferably provides that the minimum flow rate per sprinkler include a plurality of flow rates for a pendent type sprinkler with a rated K-factor of 4.2 when connected to at least one dry pipe of the network of pipes in one of the plurality of design protection areas having a horizontal ceiling with a maximum rise of two inches per foot of run, the plurality of flow rates including about 13 gallons per minute for a protected area of about 144, 196, or 256 square feet; about 18 gallons per minute for a protected area of about 324 square feet; or about 22 gallons per minute for a protected area of about 400 square feet.

In another aspect of the methods of designing the residential fire protection system, the system preferably provides that the minimum flow rate per sprinkler include a plurality of flow rates for a pendent type sprinkler with a rated K-factor of 4.2 when connected to at least one dry pipe of the network of pipes in one of the plurality of design protection areas having a sloped ceiling with a maximum rise of eight inches per foot of run, the plurality of flow rates including about 17 gallons per minute for a protected area of about 144, 196, or 256 square feet; about 19 gallons per minute for a protected area of about 324 square feet; or about 24 gallons per minute for a protected area of about 400 square feet.

In yet another aspect of the methods of designing the residential fire protection system, the system preferably provides that the minimum flow rate per sprinkler include a plurality of flow rates for two pendent type sprinklers each with a rated K-factor of 4.2 when connected to respective dry pipes of the network of pipes in one of the plurality of design protection areas having a sloped ceiling with a maximum rise of eight inches per foot of run, the plurality of flow rates including about 14 gallons per minute for a protected area of about 144, 196, or 256 square feet; or about 18 gallons per minute for a protected area of about 324 square feet. Preferably, the method provides that determining the quantity of sprinklers based on a hydraulic demand calculation provides that the calculating include providing a density of at least 0.1 gallons per minute per square foot, and more preferably provide a density of at least 0.05 gallons per minute per square foot from each of the quantity of residential fire sprinklers.

Another fire protection system residential dwelling unit fire protection system is provided. The residential dwelling unit has a plurality of compartments as defined in the 2002 National Fire Protection Association Standard 13D. The system includes a supply of pressurized liquid, a supply of pressurized gas, a control valve coupled to the liquid and gas supplies, a network of a main pipe and a branch pipe that extends over a compartment of the residential dwelling unit. The branch pipe includes a fire-resistant plastic branch pipe and fire-resistant plastic fitting coupled to the control valve and to the quantity of residential fire sprinklers. The main pipe has an internal opening being filled with liquid with a cross-sectional area different than the cross-sectional area of the internal opening of the branch pipe. The fire-resistant plastic branch pipe and fire-resistant plastic fittings being filled with a gas from the gas supply source. The control valve is disposed between the main pipe and the branch pipe. The control valve is coupled to the liquid supply and the gas supply so that the main pipe is wet with liquid and the branch pipe is dry when the control valve is in a closed position that prevents liquid from flowing through the control valve to branch pipe. The quantity of residential fire sprinklers is located adjacent each of the compartments. Each of the quantity of residential fire sprinklers is coupled to the fire-resistant plastic branch pipe filled with a gas so that, upon actuation of at least one fire sprinkler of the quantity of residential fire sprinklers, gas is expelled and liquid is delivered from liquid supply to the compartments within a first time period. And the quantity of residential fire sprinkler is based on a calculated hydraulic demand for all residential fire sprinklers, up to two sprinklers, having the highest calculated demand within a compartment.

Another fire protection system residential dwelling unit fire protection system is provided. The residential dwelling unit has a plurality of compartments as defined in the 2002 National Fire Protection Association Standard 13 R. The system includes a supply of pressurized liquid, a supply of pressurized gas, a control valve coupled to the liquid and gas supplies, a network of a main pipe and a branch pipe that extends over a compartment of the residential dwelling unit. The branch pipe includes a fire-resistant plastic branch pipe and fire-resistant plastic fitting coupled to the control valve and to the quantity of residential fire sprinklers. The main pipe has an internal opening being filled with liquid with a cross-sectional area different than the cross-sectional area of the internal opening of the branch pipe. The fire-resistant plastic branch pipe and fire-resistant plastic fittings being filled with a gas from the gas supply source. The control valve is disposed between the main pipe and the branch pipe. The control valve is coupled to the liquid supply and the gas supply so that the main pipe is wet with liquid and the branch pipe is dry when the control valve is in a closed position that prevents liquid from flowing through the control valve to branch pipe. The quantity of residential fire sprinklers is located adjacent each of the compartments. Each of the quantity of residential fire sprinklers is coupled to the fire-resistant plastic branch pipe filled with a gas so that, upon actuation of at least one fire sprinkler of the quantity of residential fire sprinklers, gas is expelled and liquid is delivered from liquid supply to the compartments within a first time period. And, the quantity of residential fire sprinkler is based on a calculated hydraulic demand for all residential fire sprinklers, up to four residential fire sprinklers, having the highest calculated demand within a compartment.

In one aspect of the systems, the first time period is preferably about 10 seconds, and is more preferably about 15 seconds. In another aspect of the fire protection systems, the residential fire sprinkler includes a residential pendant type fire sprinkler having a rated K-factor of at least nominally 4, and more preferably includes a residential sidewall sprinkler having a rated K-factor of at least nominally 4. In yet another aspect of the fire protection systems, the fire-resistant plastic components preferably include chlorinated polyvinyl chloride plastic pipes and fittings.

### BRIEF DESCRIPTIONS OF THE DRAWINGS

The accompanying drawings, which are incorporated herein and constitute part of this specification, illustrate exemplary embodiments of the invention, and, together with the general description given above and the detailed description given below, serve to explain the features of the invention.

FIGS. 1A1 and 1A2 are perspective views of a residential sprinkler system with vertically-oriented and horizontally-oriented sprinklers according to preferred embodiments.

FIGS. 1B and 1C illustrate respectively a pendent and sidewall sprinklers of FIGS. 1A1 and 1A2.

FIGS. 2A and 2B illustrate a preferred communication medium for the preferred wet or dry sprinkler design methodology.

FIGS. 3 A, 3B and 3C illustrate schematically the layout of preferred residential fire protection systems.

### DETAILED DESCRIPTION OF THE PREFERRED EMBODIMENTS

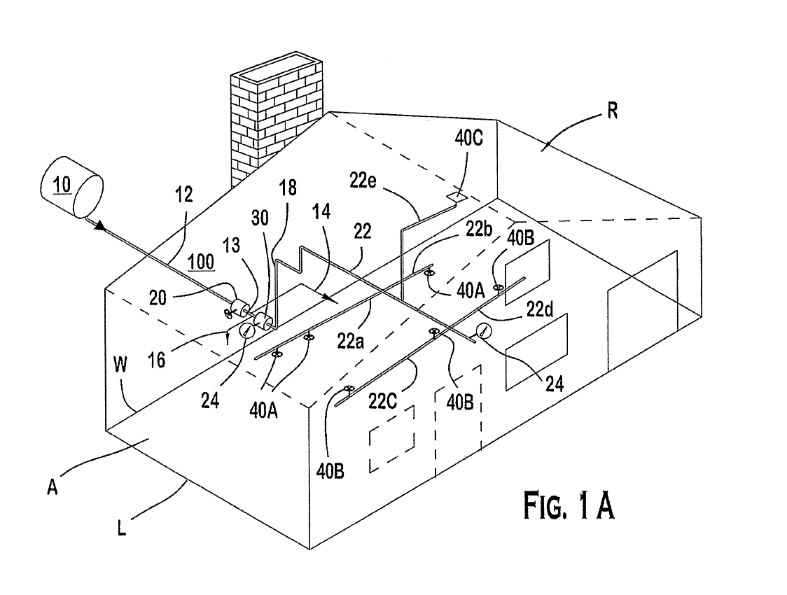

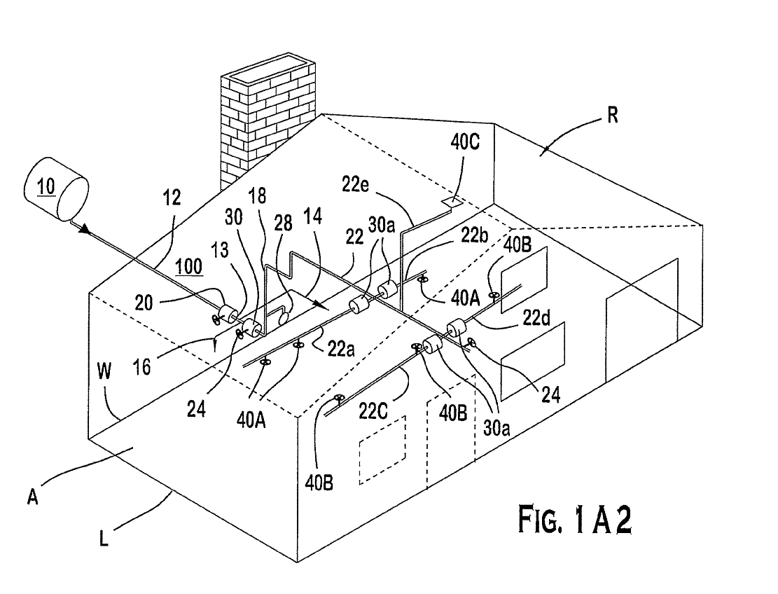

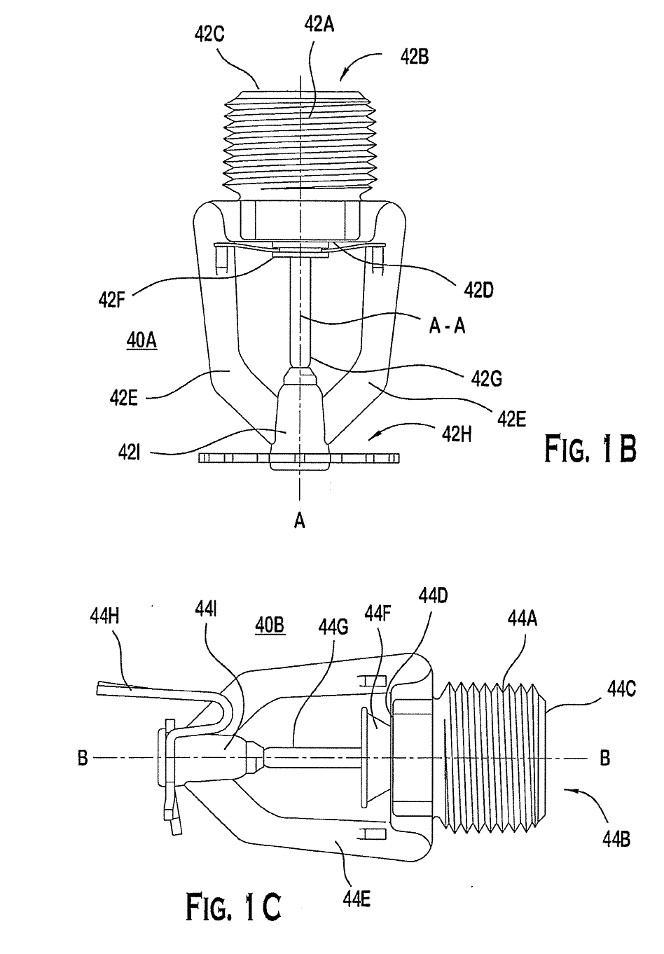

FIGS. 1-3 illustrate the preferred embodiments. In particular, FIGS. 1A1 and 1A2 show a residential dwelling unit R. As used herein, the term “residential” is a “dwelling unit” as defined in NFPA Standard 13D5 13R (2002), which can include commercial dwelling units (e.g., rental apartments, lodging and rooming houses, board and care facilities, hospitals, motels or hotels) to indicate one or more rooms, arranged for the use of individuals living together, as in a single housekeeping unit, that normally have cooking, living, sanitary, and sleeping facilities. The residential dwelling unit normally includes a plurality of compartments as defined in NFPA Standards 13, 13D, and 13R, where generally each compartment is a space that is enclosed by walls and ceiling. The standards relating to residential fire protection, including 2002 Standards 13, 13D, and 13R, as promulgated by the National Fire Protection Association (“NFPA Standard 13 (2002)”, “NFPA Standard 13D (2002)”, “NFPA Standard 13R (2002)”) and Underwriter's Laboratory Residentialfire sprinklers for Fire-Protection Service 1626 (October 2003) (“UL Standard 1626 (October 2003)”), are incorporated herein by reference in their entireties.

In the residential dwelling unit R of FIG. 1A1 an exemplary dry fire protection system can be provided for a plurality of protection areas, including sub-divided protection areas, i.e., compartments to be protected within the residential unit R. For example, in protection area A with length L and width W, a dry fire protection system can include a supply 10 of pressurized liquid such as a suitable liquid supply 10, located proximate the dwelling unit R. A network of pipes 100 is coupled to the liquid supply 10 by preferably a single supply control valve 20 that can be used to shut off liquid to both a domestic water system for the occupants via pipe 14 and for the fire protection system via pipe 18 for the residential dwelling unit R. A back-flow check valve 13 can be provided upstream of the supply control valve 20 so as to prevent contamination of the water supply. The supply control valve 20 can be coupled to a suitable dry pipe valve 30 (or other control valves) disposed between the supply control valve 20 and the piping network. A test and drain line 16 can be provided downstream of the supply control valve 20.

The liquid supply 10 can include a municipal water supply, an elevated liquid or pressurized-liquid tank, or a water storage with a water pump, which can provide a demand for a fire protection system for a suitable period, such as, for example, 10 to 30 minutes without any provisions that would prevent the use of domestic water flow by the occupants. Where a water system is designed to serve both the needs of the occupants of the dwelling unit and the fire protection system, the water system should: (1) account for water demand of more than five gallons per minute to multiple dwelling units when no provision is made to prevent the flow of the domestic water supply upon actuation of the residential fire sprinkler system; (2) include smoke or fire detector; (3) include listed or approved piping for the sprinkler system; (4) approved or permitted by local governmental authority; (5) include warning that a residential fire sprinkler system is coupled to the domestic system; and (6) not add flow restriction device such as water filter to the system.

The network of pipes can include a riser 18 coupled to a main pipe 22. The main pipe 22 can be couple to a plurality of branch pipes 22a, 22b, 22c, 22d, 22e . . . 22n extending over each of the sub-divided areas. The main pipe 22 and branch pipes 22a, 22b, 22c . . . 22n can be filled generally with a suitable gas (e.g., air or nitrogen or mixtures thereof) from a gas supply source 28 so that the pipes are “dry.” A pressure gauge 24 can be installed in the piping network 100 to provide an indication of the system pressure. The branch pipes 22a, 22b, 22c, 22d, 22e . . . 22n (where n=a suitable number of branch pipes) are coupled to a quantity of residential fire sprinklers 40A, 40B, 40C located adjacent each of the sub-divided areas. The network of pipes can be one or more suitable types of piping such as, for example, copper, iron, or plastic piping. Preferably, various components (e.g., riser, main, branch lines and fittings) of the fire protection system are fire-resistant plastics, such as, for example, chlorinated polyvinyl chloride (CPVC). More preferably, at least the pipes and fittings of the fire protection system 100 are BlazeMaster® CPVC pipes and fittings. And as used herein the term “fire-resistant plastic” indicates any plastic materials rated for use in a fire protection system by the NFPA, UL, or other classifying agency such as, for example, FM Approval Standard Class Number 1635 (November 1989).

Referring alternatively to FIG. 1A2, in certain residential dwelling unit R, the main pipe 22 can be configured to be filled with liquid (by eliminating or leaving the control valve 30 open) while the branch pipes 22a, 22b, 22c, 22d are configured to be generally free of liquid by virtue of respective control valves 30a. In such configuration of the fire protection system, the actuation of a residential sprinkler in one compartment would not lead to branch pipes in other compartments being filled with liquid. Furthermore, the internal opening of the main pipe 22 can have a cross-sectional area different than the cross-sectional area of the opening of the branch pipes 22a-22d. The main pipe 22 can be of a suitable non-fire-resistant plastic such as a non-plastic (e.g., copper) material while the branch pipes can be fire-resistant plastic; the main and branch pipes can be non-fire-resistant plastic (e.g., copper or ferrous); or the main pipe can be a fire-resistant plastic main pipe with non-plastic (e.g., copper or ferrous) branch pipes. Preferably, the cross-sectional area of the main pipe opening is greater than the cross-sectional area of the branch pipes. Also preferably, the main pipe 22, at least the branch pipes 22a-22d and any required fittings between the pipes are BlazeMaster® CPVC pipes and fittings.

Depending on the system design, the residential fire sprinklers can be vertically-oriented type fire residential fire sprinklers that are approved for dry residential applications. The vertically oriented type residential fire sprinklers can include, for example, pendent sprinkler 40A, upright sprinkler 40B, flush, or concealed pendent residential fire sprinklers. The residential fire sprinklers can be horizontally-oriented residential fire sprinklers that are approved for dry residential applications. The horizontally-oriented type residential fire sprinklers can include for example, sidewall sprinkler 40C, flush or concealed sidewall residential fire sprinklers.

Referring to FIG. 1B, the pendent type residential fire sprinkler 40A of the dry pipe networks of FIGS. 1A1 and 1A2 are shown in further detail. In particular, the sprinkler 40A includes a body 42A defining a passageway 42B between an inlet opening 42C and an outlet opening 42D along a longitudinal axis A-A oriented generally perpendicular to the protection area A. The body 42A is coupled to a dry pipe system so that the passageway 42B is filled with a dry gas or air. The passageway 42B has a rated K-factor, where the rated K-factor equals the flow of water in gallons per minute through the passageway divided by the square root of the pressure of water fed to the body in pounds per square inch gauge (GPM(psig)^{1/2}). The rated K-factor can include, but is not limited to, any one of nominally 3.0, 3.9, 4.1, 4.2, 4.3, 4.4, 4.7, 4.9, 5.5, or 5.6 K-factor. The body 42A has at least one frame arm 42E coupled to the body 42A proximate the outlet opening 42D. A closure 42F can be positioned proximate the outlet opening 42D so as to occlude the passageway 42B. A heat responsive trigger 42G can be provided to retain the closure 42F so as to close the passageway. A deflector 42H can be coupled with the body through at least one frame arm 42E and nosepiece 421 so that the deflector 42H is spaced from and generally aligned with the outlet opening and the longitudinal axis A-A. The upright residential sprinkler 40B can include many similar components as the residential pendent sprinkler 40A and therefore has not been described to maintain brevity in this description. When the heat responsive trigger 42G is actuated, the closure 42F is positioned to allow the dry gas to be expelled from the dry pipes and the passageway 42B and for a flow of water to fill the previously-dry pipes and issue from the outlet opening 42D along axis A-A. The flow of water through the body 42A can include various flow rates, such as, for example, about 13, 16, 17, 19, 21, or 24 gallons per minute. The flow of water or a fire-fighting liquid through the dry pipe system is distributed over the protection area by the deflector so that the sprinkler by itself, or in conjunction with other sprinklers, protects the area of the residential dwelling unit.

Referring to FIG. 1C, the sidewall residential sprinkler 40C of the dry pipe systems of FIGS. 1A1 and 1A2 is shown in further detail. In particular, the sprinkler 40C includes a body 44A defining a passageway 44B between an inlet opening 44C and an outlet opening 44D along a horizontal axis B-B oriented generally parallel to the protection area A. The passageway 44B has a rated K-factor, where the rated K-factor equals the flow of water in gallons per minute through the passageway divided by the square root of the pressure of water fed to the body in pounds per square inch gauge (GPM/(psig)^{1/2}). The rated K-factor can include, but is not limited to, any one of nominally 4 or 5 K-factor. The body 44A has at least one frame arm 44E coupled to the body 44A proximate the outlet opening 44D. A closure 44F can be positioned proximate the outlet opening 44D so as to occlude the passageway 44B. A heat responsive trigger 44G can be provided to retain the closure 44F so as to close the passageway. A deflector 44H can be coupled with the body through at least one frame arm 44E and nosepiece 441 so that the deflector 44H is spaced from and generally aligned with the outlet opening and the longitudinal axis A-A. When the heat responsive trigger 44G is actuated, the closure 44F is positioned to allow the dry gas to be expelled from the dry pipes and the passageway 44B and for a flow of water to fill the previously-dry pipes and issue from the outlet opening 44D along axis B-B. The flow of water through the body 44A can include various flow rates, such as, for example, about 12, 13, 14, 16, 17, 18, 19, 20, 21, 23, 24, 25, 26, 27, or 28 gallons per minute. The flow of water or a fire-fighting liquid through the dry pipe system is distributed over the protection area by the deflector so that the sprinkler by itself, or in conjunction with other sprinklers, protects the area of the residential dwelling unit. Thus, the means for distributing the fire-fighting liquid over a protection area of a residential dwelling unit can be any particular structures of the residential sidewall sprinkler 40B, which in the preferred embodiments include at least the deflector 44H.

Although no residential fire sprinklers have been approved for residential use with a piping network filled with a gas (i.e., “dry”) instead of a network filled with liquid (i.e., “wet”), applicant has discovered that residential fire sprinklers, which were approved for use only in wet pipe residential fire protection system, would meet the approval requirements of NFPA Standard 13 (2002), 13D (2002) and 13R (2002) and UL Standard 1626 (October 2003). This discovery has allowed a residential fire sprinkler system with a dry pipe network to be designed by determining a quantity and location of residential fire sprinklers required to determine a hydraulic demand calculation of the residential fire sprinklers. Applicant has discovered that, for certain applications in accordance with NFPA 13, 13D, and 13R, the quantity and location of residential fire sprinklers in a piping network filled with a fire-fighting liquid can be used to determine a hydraulic demand of residential fire sprinklers coupled to a piping network filled with a gas.

In particular, referring to FIGS. 1A1 and 1A2, the quantity and location of residential fire sprinklers for a residential dwelling unit can be determined based on a hydraulic demand of the most hydraulically remote fire sprinkler within a compartment of the residential dwelling unit. Where the residential dwelling unit can be classified as a one or two-family dwelling unit, as defined in NFPA Standard 13D (2002), the hydraulic demand of a system for the dwelling unit can be determined by assessing a hydraulic demand of a residential fire sprinkler, up to two sprinklers, for a design area of each compartment while taking into account any obstructions on the walls or ceiling. Specifically, for each compartment, one or more residential fire sprinklers (as approved by an authority having jurisdiction over fire protection design to provide sufficient liquid density) can be selected. The selected residential fire sprinklers, i.e., design sprinkler, in the selected compartment can be used to determine if the design sprinklers, up to two sprinklers, located at specified locations within any one of selected compartments, have the highest hydraulic demand of a wet pipe fire protection system for the residential dwelling unit. For each compartment, the hydraulic demand is calculated based on the location of the design sprinklers from the liquid supply source to the wet pipe network for, in some cases, all of the compartments. From the calculated hydraulic demand of some or all the compartments, the highest hydraulic demand for a particular compartment of the residential dwelling unit can be determined. This highest hydraulic demand is then compared with an actual liquid flow rate and pressure of the liquid supply. Where the highest hydraulic demand can be met by the actual liquid supply for the residential dwelling unit, the quantity of fire sprinklers is the sum of all the design sprinklers within the residential dwelling unit in the design of a dry pipe residential fire protection system of the dwelling unit. Thereafter, the design can be implemented, at a minimum, in accordance with installation guidelines set forth in NFPA Standard 13D (2002).

Where the residential dwelling unit can be classified as a residential dwelling unit up to and including four stories in height, as defined in NFPA Standard 13R (2002), the hydraulic demand of a system for the dwelling unit can be determined by assessing a hydraulic demand of a residential fire sprinkler, up to two sprinklers, for a design area of each compartment while taking into account any obstructions on the walls or ceiling. Specifically, for each compartment, one or more residential fire sprinklers (as approved by an authority having jurisdiction over fire protection design to provide sufficient liquid density) can be selected. The selected residential fire sprinklers, i.e., design sprinklers, in the selected compartment can be used to determine if the design sprinklers, up to four residential fire sprinklers, located at specified locations within any one of selected compartments, have the highest hydraulic demand of the fire protection system for the residential dwelling unit. For each compartment, the hydraulic demand is calculated based on the location of the design sprinklers from the liquid supply source to the wet pipe network for, in some cases, all of the compartments. From the calculated hydraulic demand of some or all the compartments, the highest hydraulic demand for a particular compartment of the residential dwelling unit can be determined. This highest hydraulic demand is then compared with an actual liquid flow rate and pressure of the liquid supply. Where the highest hydraulic demand of the residential dwelling unit can be met by the actual liquid supply for the residential dwelling unit, the quantity of fire sprinklers is the sum of all the design sprinklers within the residential dwelling unit in the design of a dry pipe residential fire protection system of the dwelling unit. Thereafter, the design can be implemented in accordance, at a minimum, with installation guidelines set forth in NFPA Standard 13R (2002).

Applicant has verified that the hydraulic demand design criteria of a wet pipe residential fire sprinkler system are applicable to a dry pipe system by tests based on guidelines set forth by NFPA Standards 13, 13D, 13R (2002) and UL Standard 1626 (October 2003). Based on testing in accordance with these guidelines, it has been discovered that residential fire sprinklers can deliver the required density set forth by NFPA Standards 13, 13D, 13R (2002 Eds.) and UL Standard 1626 (October 2003) within the maximum water delivery time of 15 seconds to the Most-Hydraulically-Remote residential fire sprinkler, as set forth in NFPA Standard 13 (2002), Table 11.2.3.9.1, at the required density of 0.05 gpm/sq. ft. in a dry pipe system while meeting the testing requirements of UL Standard 1626 (October 2003).

In particular, each of the plurality of residential fire sprinklers includes a pendant type fire sprinkler having a rated K-factor of at least nominally 4, as shown and described in Tyco Fire Product Datasheet TFP 400 Series II Residential Pendent Sprinklers 4.9 K-factor (April 2004) and identified by Sprinkler Identification Number TY2234, which datasheet is incorporated herein by reference in its entirety; a sidewall residential fire sprinkler having a rated K-factor of at least nominally 4, as shown and described in Tyco Fire Product Datasheet TFP 410 Series II LFII Residential Horizontal Sidewall Sprinklers 4.2 K-factor (April 2004) and identified by Sprinkler Identification Number TY1334, which datasheet is incorporated herein by reference in its entirety; and a flush-pendent residential fire sprinkler having a rated K-factor of at least nominally 4, as shown and described in Tyco Fire Product Datasheet TFP 410 Series II LFII Residential Flush Pendent Sprinklers 4.2 K-factor (April 2004), and identified by Sprinkler Identification Number TY2284, which datasheet is incorporated herein by reference in its entirety. As used herein, the term “nominally” or “nominal” indicates ±10% in variations from the values indicated.

Applicant has verified his discovery of residential fire sprinklers for use in residential dry pipe system applications with tests that were previously used for wet systems. For example, the identified pendent sprinklers TY1334, TY2234, and TY2284 have complied with requirements for a wet system as set forth by NFPA Standards 13, 13D, 13R (2002 Eds.) and UL Standard 1626 (October 2003) for various ceiling configurations including flat, sloped and beamed ceilings. A brief description of the test procedures that were used to verify their discovery is provided below.

For test configurations to determine the horizontal water distribution of existing vertically oriented residential sprinkler (e.g., upright or pendent) and horizontally oriented residential fire sprinklers (e.g., sidewall), UL Standard 1626 (October 2003) requires placing a selected sprinkler over a protective area sub-divided into four quadrants with the sprinkler placed in the center of the quadrants. Water collection pans are placed over one quadrant of the protective area so that each square foot of the quadrant is covered by collector pan of one-square foot area. For vertically oriented type sprinklers, the top of the collector pan is 8 feet below a generally flat ceiling of the test area. For horizontally oriented type sprinkler, the top of each collection pan is about six feet ten inches below the ceiling. The area is generally the product of a coverage width and length. The length L of the quadrant is generally the one-half the coverage length and the width W is generally one-half the coverage width. Water is supplied to the selected sprinkler at the flow rate specified in the installation instruction provided with the sprinkler being tested via a one-inch internal diameter pipe with a T-fitting having an outlet at substantially the same internal diameter as the inlet of the selected sprinkler. The duration of the test is twenty-minutes and at the completion of the test, the water collected by the pan is measured to determine if the amount deposited complies with the minimum density requirement. Additional details of this test are shown and described in UL Standard 1626 (October 2003), which is incorporated herein by reference.

For test configurations to determine vertical water distribution of other existing vertically oriented residential sprinkler (e.g., upright or pendent) and horizontally oriented residential fire sprinklers (e.g., sidewall) UL Standard 1626 (October 2003) provides for two arrangements. In the first arrangement for vertically oriented sprinkler, the sprinkler is placed at one-half the coverage length or width. In the second arrangement for horizontally-oriented sprinkler, the sprinkler is placed below the generally flat ceiling but no lower than twenty-eight inches below the ceiling on one wall surface and at no greater than one-half the distance of an uninterrupted surface of a wall. Water is delivered to the sprinkler at the flow rate specified in the installation instruction provided with the sprinkler being tested via a one-inch internal diameter pipe. Water collection pans of one-square foot area are placed on the floor against the walls of the test area so that the top of the pan is six feet, ten inches below a nominally eight feet generally flat ceiling. The duration of the test is ten-minutes at which point the walls within the coverage area should be wetted to within 28 inches of the sprinkler at the specified design flow rate. Where the coverage area is square, each wall must be wetted with at least five percent of the sprinkler flow. Where the coverage area is rectangular, each wall must be wetted with a proportional water amount collected that is generally equal to 20 percent of times the length of the wall divided by the perimeter of coverage area.

Actual fire tests can also be performed in accordance with UL Standard 1626 (October 2003) for each type of residential fire sprinklers. In particular, three tests arrangement can be utilized within a room with nominally eight feet generally horizontal or flat ceiling and simulated furniture so that the tested residential sprinkler can limit temperatures at four different locations to specified temperatures. In all three test arrangements, a rectangular-shaped coverage area is provided with first and second parallel walls whose length are longer than third and fourth walls that extend orthogonally to each of the first and second walls. The third and fourth walls are each provided with an entrance; one entrance with 35 inches of width and the other entrance with 41 inches of width.

Two sprinklers to be tested are spaced apart over a first distance to provide liquid distribution over the protected area. A third sprinkler to be tested is disposed proximate the larger width opening. Simulated funitures are oriented in an orthogonal configuration to generally surround a wood crib and one corner of the protected area distal to the smaller opening. A first thermocouple is located 0.25 inches above the ceiling and 10 inches diagonally from the one corner. A second thermocouple is located in the geometric center of the room and three inches below the ceiling. Additional details of the test room, fire source burning characteristics, sprinkler installation and exact parameters for carrying out the fire tests are provided in UL Standard 1626 (October 2003).

In the first fire testing arrangement for vertically-oriented sprinklers (e.g., pendent, upright, flush, recessed pendent and concealed), a third thermocouple can be located three inches below the ceiling and eight inches from a first sprinkler located nearest the simulated furniture. The first sprinkler is located at a distance L from a second sprinkler so that the first sprinkler is located at one-half L from the third wall with the smaller opening. A third sprinkler is located three feet from the second wall and four inches from the larger opening.

In the second fire testing arrangement for horizontally-oriented sprinklers, first and second sprinklers are mounted in the wall distal to the simulated furniture and spaced apart over a distance W so that the first sprinkler is nearest the smaller opening and located at a distance of one-half W to the third wall having the smaller opening. The second sprinkler is about nominally eight feet from a third sprinkler mounted on the wall. A third thermocouple is located directly across from the first sprinkler at a distance of one-half the width of the room, at three inches below the ceiling and 5 feet and one-quarter inches above the floor.

In the third fire testing arrangement for horizontally-oriented sprinklers, the first and second sprinklers are mounted in the wall proximal to the simulated furniture and spaced apart over a distance W along the wall. A third thermocouple is located in the same location as in the second testing arrangement.

In all three fire-testing arrangements, when the fire sources are ignited in accordance with UL Standard 1626 (October 2003), the residential fire sprinklers provide a predetermined water flow rate within fifteen seconds of actuation of at least one sprinkler over the coverage area to limit the maximum temperature measured by the second and third thermocouples cannot exceed 600 degrees Fahrenheit (“degrees F”). To comply with UL Standard 1626 (October 2003), the maximum temperature measured by the third thermocouple cannot exceed 200 degrees F. and cannot exceed more than 130 degrees F. for any continuous duration of more than two minutes. To comply with UL Standard 1626 (October 2003), the maximum temperature measured by the first thermocouple cannot exceed 500 degrees F.

As can be seen above, it has been discovered that the design criteria in the dry residential system for the protection area A of FIGS. 1A1 and 1A2 is the same design criteria for residential fire sprinklers in a wet residential system for the protection area A of the residential unit R of FIGS. 1A1 and 1A2. Such discovery is believed to be heretofore unknown and unexpected in the fire protection art. This discovery has allowed an implementation of a method not previously available in the art. This method provides for at least the design, classification, approval, and implementation of dry sprinkler and dry sprinkler system, e.g., with fire-resistant plastic components, in residential dwelling unit, which residential sprinkler and dry sprinkler system are believed to provide the same or similar protection of a wet fire protection system without the difficulties that may be encountered with a wet system, e.g., leakage or unexpected expulsion of water from the sprinklers.

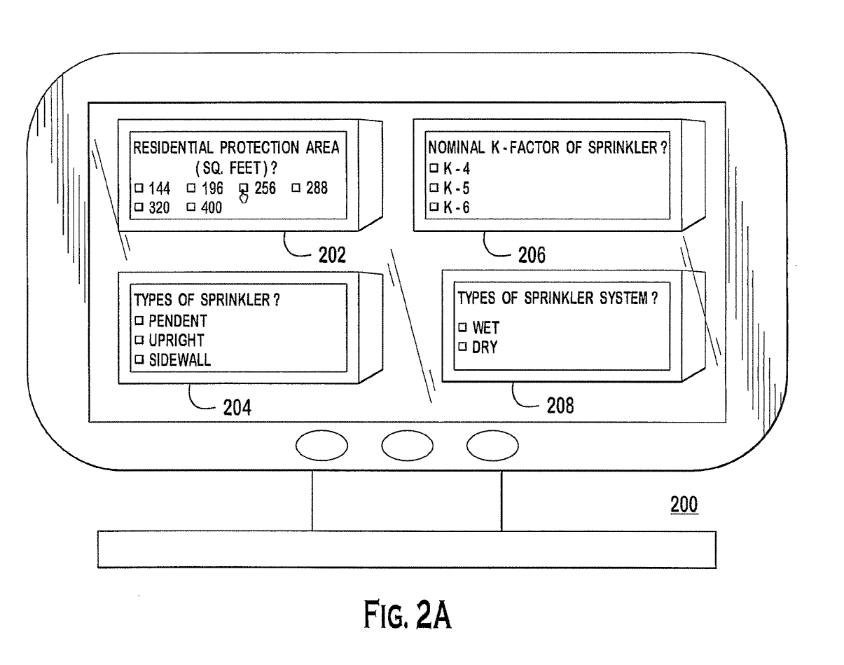

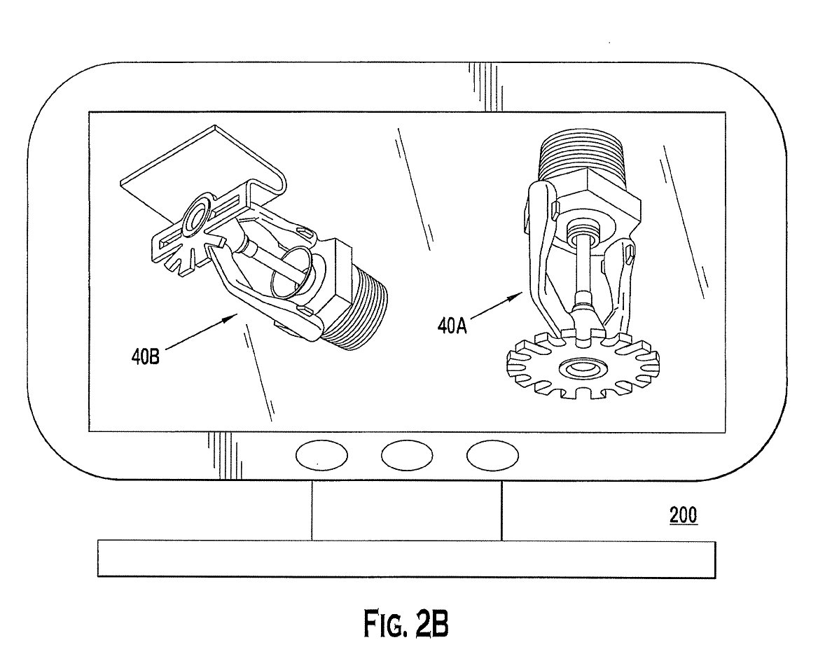

Moreover, by virtue of applicant's discovery, individuals associated with residential fire protection are now able to specify a design protection area and determine at least the following design parameters for the specified design protection area: (1) which specific sprinklers are suitable for use with the same quantity of sprinklers for wet or dry residential fire sprinklers; (2) the types of ceiling consonant with the specified sprinkler; (3) the specified coverage areas for each type of ceiling over a protection area; (4) the flow rate and residual pressure for each specified coverage area in each type of ceiling over a protection area; for each of wet or dry pipe systems; and (5) the type of fire-resistant plastic components. And these individuals are now able to obtain the parameters identified above in a suitable communication medium that would facilitate the design process for these individuals. For example, as shown in FIGS. 2A and 2B, the communication media can be a computer with a graphical user interface.

Referring to FIGS. 2A and 2B, a user can load a program into a communication medium (e.g., a computer 200) that embodies appropriate computational engines such as, for example, a database of operational characteristics of residential fire sprinklers. The computer 200 would receive appropriate operational parameters of an area to be protected for a residential application and would provide appropriate selections (via dialogs 202, 204, 206, 208 or a menu) of residential fire sprinklers suitable for at least a dry pipe system of such residential application. By way of example, the user can select from a menu or provide arbitrary values of an actual protection area and various parameters of such area (e.g., obstructions or ceiling offset) in a dialog type entry; select the type of sprinkler (e.g., upright, pendent, sidewall, or flush pendent, flush sidewall); select the appropriate nominal rated K-factor; and select either or both wet and dry pipe systems. Once the appropriate parameters have been entered into the computer, the computational engines programmed into the computer are then used to provide the user with a choice of residential fire sprinklers appropriate for such design, such as, for example, the identification of appropriate sprinklers, the quantity of sprinklers necessary for both wet or dry pipe system.

The user can obtain graphical tabulations of design parameters for both wet and dry pipe residential systems in a different communication medium. In a paper medium, the design parameters can be tabulated as appropriate for the type of design protection area based on any suitable lead criterion. The lead criterion is chosen to be the type of ceiling. Based on this lead criterion, the design parameters are then provided to the user in the form of maximum coverage area; maximum spacing between sprinklers; spacing between deflector of sprinkler to ceiling; and flow rate with residual pressure required for these design parameters. As another example, the lead criterion can be the type of sprinkler (e.g., upright, pendent, sidewall) so that the appropriate tabulation of design parameters consonant with the lead criterion can be provided. Hence, the lead criterion can be selected from any of the design parameters and the appropriate design parameters consonant with the lead criterion can be tabulated and provided in a suitable communication medium. Although one electronic communication medium has been described, other communication mediums are also suitable, such as, for example, an internet terminal, a voice prompt wireless communication medium (e.g., cellular telephone) or voice prompt toll-free wire communication (e.g., land line telephone). Alternatively, the communication medium could be paper.

Regardless of the particularity of the communication medium, the medium would preferably include an identification of fire protection information, such as, for example, (1) at least one type of fire sprinkler for each of the plurality of protected areas; (2) a plurality of areas to be protected in the dwelling unit, each of the plurality of design protection areas having a dimension of X by Y, wherein X is any value from 10 feet to 20 feet and Y is any value from 10 feet to 24 feet; and (3) a plurality of minimum flow rates and residual pressures for a respective plurality of areas. The communication medium would also include a description of wet and dry pipe residential fire sprinkler networks that directs a user to design a residential fire protection system with the same quantity of the at least one residential fire sprinkler in one of wet or dry pipe system in a dwelling unit based on the identification of fire protection information such as, for example, a calculation to determine the quantity of residential fire sprinklers.

The identification of fire protection information can also include information of protection areas in relation to at least one of the following: (a) type of ceiling over the design protection area such as, for example, generally flat, sloped, or beamed ceiling; (b) spacing between any two of the at least one type of residential fire sprinklers; (c) rated K-factor of the at least one type of fire sprinkler such as a nominal rated K-factor of 4 or 5; (d) minimum flow rate per sprinkler such as, for example, a plurality of flow rates for a pendent type residential sprinkler with a rated K-factor of 4.9 when coupled to at least one dry pipe of the network of pipes in one of the plurality of design protection areas having a variety of ceiling configurations; and (e) the material for various components of the fire protection system such as, for example, CPVC pipes and fittings.

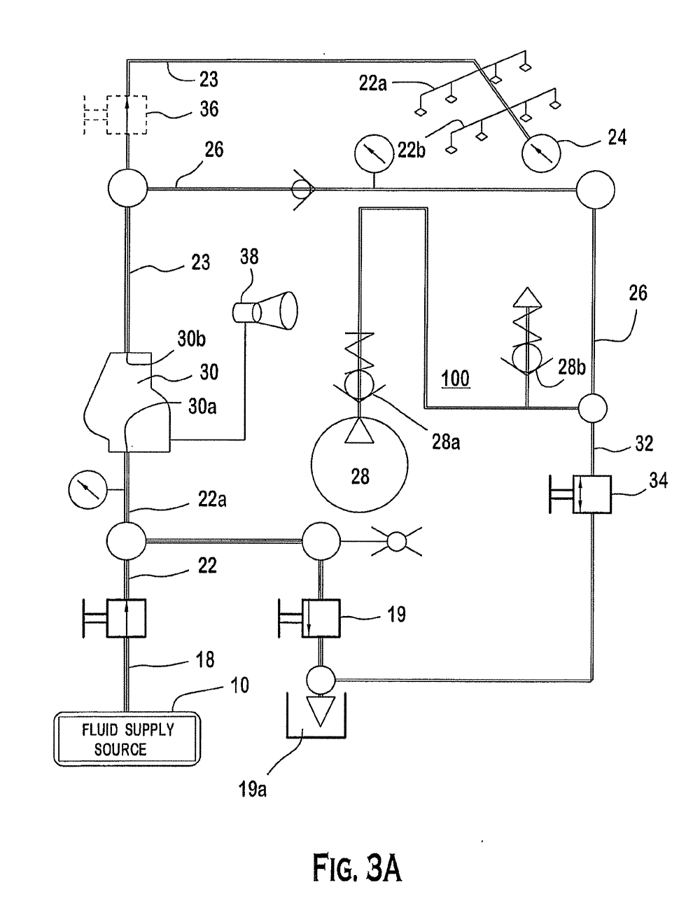

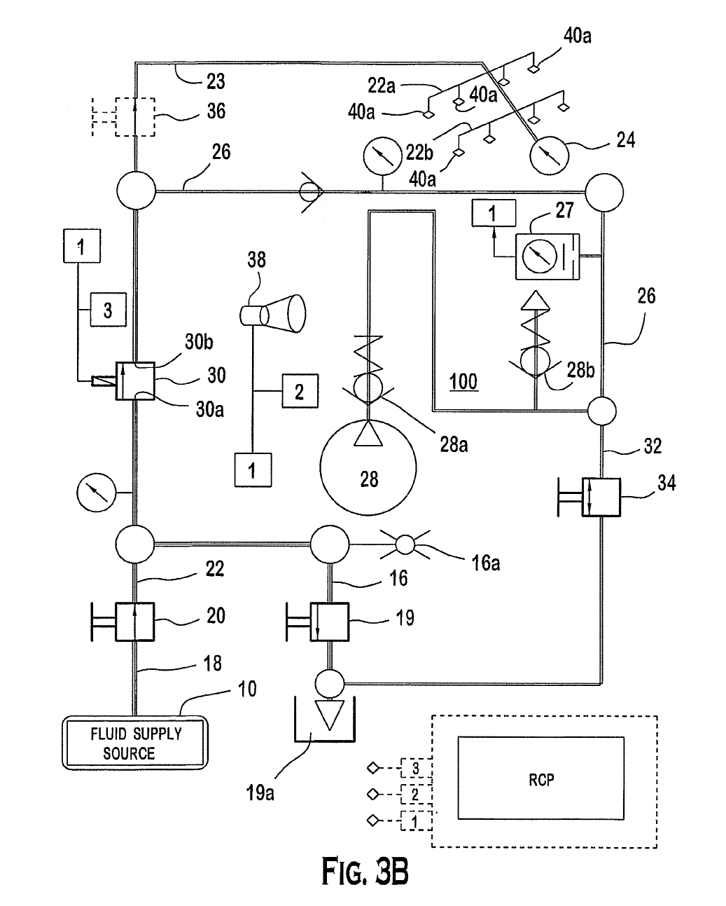

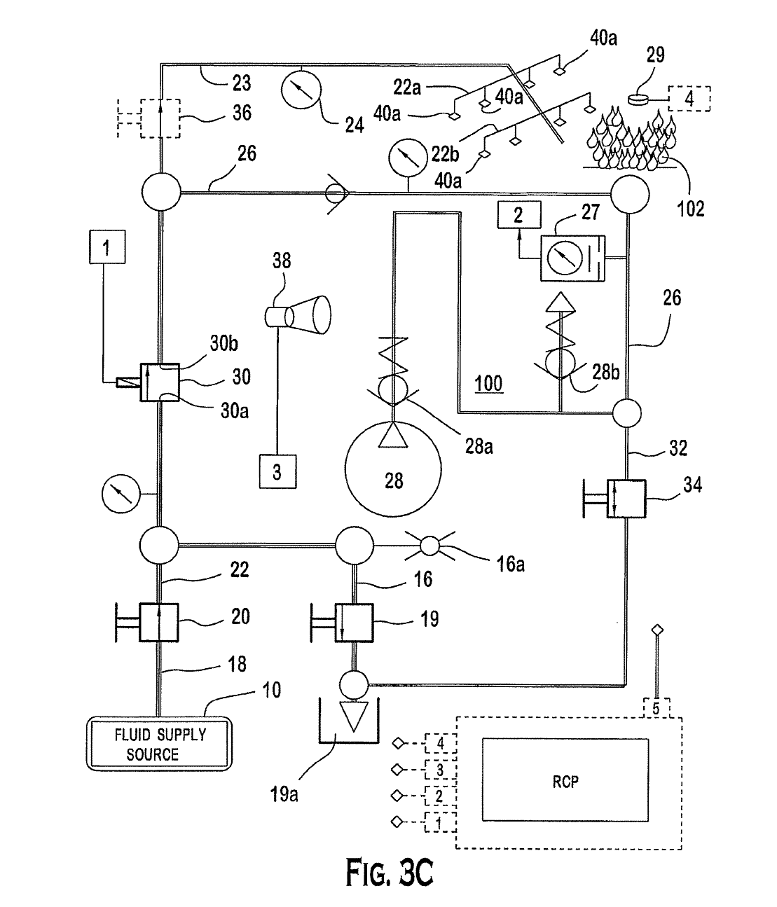

The description provided above can be used to design a residential fire protection system. Referring to FIG. 3A, a first preferred embodiment of such residential fire protection system is illustrated in schematic form. In particular, the liquid supply source 10 is in fluid communication with the supply control valve 20 via the riser 18. A drain line 16, with a test port fitting 16a, can be coupled in fluid communication with the main pipe 22 with a normally-closed drain valve 19 to drain 19. The supply control valve 20 is in fluid communication via main pipe 22 with an inlet 30a of the control valve 30 (e.g., a dry pipe valve). Downstream of the control valve 30, a main pipe 23 and a gas pipe 26 is in fluid communication with an outlet 30b of the control valve 30. The gas pipe 26 is in fluid communication with a pressurized gas source 28. A check valve 28a can be provided proximate the gas source 28 to prevent influx of liquid. A relief valve 28b can also be provided downstream of the gas source 28 to prevent over-pressurization of the gas pipe 26. A drain 32 with a normally-closed drain valve 34 can also be coupled for fluid communication with the gas pipe 26. Optionally, a control valve 36 can be provided downstream of the gas pipe 26. An alarm device 38 can also be provided to signal the actuation of the control valve or one of the residential fire sprinklers. The alarm device 38 can be a device responsive to the presence of liquid in the main pipe 23, such as, for example, an electronic device that senses the presence of liquid and provide human-perceivable signals (light or noise) or a mechanical device that provides an alarm actuated by the pressure of water flowing through the main pipe 23.

In operation of the first preferred embodiment, the supply control valve 20 is placed in a closed position to prevent a flow of liquid to the main pipe 22. The control valve 30 is configured in a closed position with the gas in the gas pipe 26 is preferably pressurized to about ⅙ of the pressure of the liquid in the liquid supply source 10. The gas flows from the gas supply 28 through line 26, main pipe 23, branch lines 22a, and the body of each unactuated residential fire sprinklers. Once a predetermined gas pressure (e.g., 28-34 psig) is reached as indicated by gauge 24, the supply control valve 20 is opened, thereby allowing liquid to flow into the inlet 30a of the control valve 30 but not to main line 23. At this point, the system 100 is in a standby mode because the system 100 is now filled with pressurized gas while liquid is prevented from entering the main line 23. When a residential fire sprinkler is actuated, the gas in the main pipe 23 and branch lines 22a and 22b is expelled through the actuated residential fire sprinkler. This reduction in gas pressure causes the control valve 30 to open, allowing liquid to flow through the main line 23, branch lines 22a, 22b and to at least the actuated residential fire sprinkler, which distributes the liquid in a predetermined density over an area to protected from a fire in a compartment of a residential dwelling unit within a predetermined time period elapsing from the actuation of the residential fire sprinkler. Due to the flow of liquid through the control valve 30, the alarm device 38 is actuated to provide a signal indicative of the actuation of the fire protection system 100.

Referring to FIG. 3B, a second preferred embodiment of a residential fire protection system is illustrated in schematic form. In particular, the liquid supply source 10 is in fluid communication with the supply control valve 20 via the riser 18. A drain line 16, with a test port fitting 16a, can be coupled in fluid communication with the main pipe 22 with a normally-closed drain valve 19 to drain 19a. The supply control valve 20 is in fluid communication via main pipe 22 with an inlet 30a of the control valve 30 (e.g., an electromagnetically actuated valve). Downstream of the control valve 30, a main pipe 23 and a gas pipe 26 is in fluid communication with an outlet 30b of the control valve 30. Preferably, each of the inlet 30a and outlet 30b has an opening with a nominal internal diameter less than two inches. The gas pipe 26 is in fluid communication with a pressurized gas source 28. A check valve 28a can be provided proximate the gas source 28 to prevent influx of liquid. A relief valve 28b can also be provided downstream of the gas source 28 to prevent over-pressurization of the gas pipe 26. A sensor 27 can be used to detect a change in gas pressure in the branch lines of the piping network. The sensor 27 can be set to one of various threshold pressures, at which threshold value will cause the sensor 27 to provide an output signal 1. Where the sensor 27 is configured as a switching relay with a sensor, the sensor 27 can be used to energize the electromagnetic valve 30 towards an open position. Alternatively, the sensor 27 can be configured to provide a signal 1 to a releasing control panel RCP, which determines when to actuate the control valve 30 via signal line 3. A drain 32 with a normally-closed drain valve 34 can also be coupled for fluid communication with the gas pipe 26. Optionally, a control valve 36 can be provided downstream of the gas pipe 26. An alarm device 38 can also be provided to signal the actuation of the control valve or one of the residential fire sprinklers. The alarm device 38 can be a device responsive to the presence of liquid in the main pipe 23, such as, for example, an electronic device that senses the presence of liquid and provide human-perceivable signals (light or noise) or a mechanical device that provides an alarm actuated by the pressure of water flowing through the main pipe 23. Where the sensor 27 is configured as a relay, the alarm 38 can be coupled to the sensor 27 so that the sensor 27 actuates both the control valve 30 and the alarm device 38. Where a releasing control panel RCP is utilized, the RCP can provide a separate signal via signal line 2 to the alarm device 38.

In operation of the second preferred embodiment, the supply control valve 20 is placed in a closed position to prevent a flow of liquid to the main pipe 22. Due to its configuration as a normally closed valve, i.e., a valve that occludes flow in the absence of any actuation signal, the control valve 30 occludes water from flowing through the valve 30 to the pipe 23. Gas, on the other hand, is permitted to flow from the gas supply 28 through line 26, main pipe 23, branch lines 22a, and the body of each unactuated residential fire sprinklers. Once a predetermined gas pressure (e.g., 28-34 psig) is reached as indicated by gauge 24, the supply control valve 20 can be opened, thereby allowing liquid to flow into the inlet 30a of the control valve 30 but not to main line 23. At this point, the system 100 is in a standby mode because the system 100 is now filled with pressurized gas while liquid is prevented from entering the main line 23. When a residential fire sprinkler is actuated, the gas in the main pipe 23 and branch lines 22a and 22b is expelled through the actuated residential fire sprinkler. This reduction in gas pressure is detected by sensor 27 which, depending on the configuration of the sensor 27, can either actuate the control valve 30 directly towards an open position or send a signal to the RCP, which can be configured or programmed to determine a suitable time frame at which to actuate control valve 30 towards an open position. Once the control valve 30 is opened, gas is expelled and liquid flows through the main line 23, branch lines 22a, 22b and to at least the actuated residential fire sprinkler, which distributes the liquid in a predetermined density over an area to protected from a fire in a compartment of a residential dwelling unit within a predetermined time period elapsing from the actuation of the residential fire sprinkler. The alarm device 38 can also be actuated directly by the sensor 27 or indirectly via the releasing control panel RCP to provide a signal indicative of the reduction in gas pressure and hence the actuation of the fire protection system 100.

Referring to FIG. 3C, a third preferred embodiment of a residential fire protection system is illustrated in schematic form. In particular, the liquid supply source 10 is in fluid communication with the supply control valve 20 via the riser 18. A drain line 16, with a test port fitting 16a, can be coupled in fluid communication with the main pipe 22 with a normally-closed drain valve 19 to drain 19a. The supply control valve 20 is in fluid communication via main pipe 22 with an inlet 30a of the control valve 30 (e.g., an electromagnetically or solenoid actuated valve). Downstream of the control valve 30, a main pipe 23 and a gas pipe 26 is in fluid communication with an outlet 30b of the control valve 30. Preferably, each of the inlet 30a and outlet 30b has an opening with a nominal internal diameter less than two inches. The gas pipe 26 is in fluid communication with a pressurized gas source 28. A check valve 28a can be provided proximate the gas source 28 to prevent influx of liquid into the gas source 28. A relief valve 28b can also be provided downstream of the gas source 28 to prevent over-pressurization of the gas pipe 26. A sensor 27 can be used to detect a change in gas pressure in the branch lines of the piping network. The sensor 27 can be set to one of various threshold pressures, at which threshold value will cause the sensor 27 to provide an output signal 2. The sensor 27 can be configured to provide a signal 2 to a releasing control panel RCP, which determines when to actuate the control valve 30 via signal line 3. A fire detection device 29 that detects the occurrence of smoke, heat or flame 102 (to indicate the occurrence of a fire) is coupled to the releasing control panel via signal line 4. An alarm 38 is coupled to the RCP via signal line 3. The RCP can be coupled to a remote monitoring station via signal lines 5 or through a suitable communication interface such as, for example, telephone, wireless digital communication or via an internet connection. The RCP can be used to actuate an alarm device 38 or the control valve 20 based on a combination of either the signal 2 from the pressure switch sensor 27 or a fire detection device 29 via signal 4. Alternatively, the RCP can actuate the alarm device 38 and the control valve 20 based on both signals from the sensor 27 and device 29 or one of the signals from the sensor 27 or device 29. A drain 32 with a normally-closed drain valve 34 can also be coupled for fluid communication with the gas pipe 26. Optionally, a control valve 36 can be provided downstream of the gas pipe 26.

In operation of the third preferred embodiment, the supply control valve 20 is placed in a closed position to prevent a flow of liquid to the main pipe 22. Due to its configuration as a normally closed valve, i.e., a valve that occludes flow in the absence of any actuation signal, the control valve 30 occludes water from flowing through the valve 30 to the pipe 23. Gas, on the other hand, is permitted to flow from the gas supply 28 through line 26, main pipe 23, branch lines 22a, and the body of each unactuated residential fire sprinklers. Once a predetermined gas pressure (e.g., 28-34 psig) is reached as indicated by gauge 24, the supply control valve 20 is opened, thereby allowing liquid to flow into the inlet 30a of the control valve 30 but not to main line 23. At this point, the system 100 is in a standby mode because the system 100 is now filled with pressurized gas while liquid is prevented from entering the main line 23. When a residential fire sprinkler is actuated, the gas in the main pipe 23 and branch lines 22a, 22b is expelled through the actuated residential fire sprinkler. This reduction in gas pressure is detected by sensor 27 which sends a signal to the RCP. In a preferred embodiment, the RCP can be configured or programmed to determine a suitable time frame at which to actuate control valve 30 towards an open position such as, for example, in a time frame prior to the actuation of any residential fire sprinkler so as to fill the main and branch lines with liquid (i.e., to “preactuate” the fire protection system). Alternatively, the RCP can delay the actuation of control valve 30 until the receipt of signals from the fire detection device 29. Yet in a further alternative, the RCP can delay the actuation of control valve until both the sensor 27 and device 29 are activated with supervisory control from a monitoring station via signal lines 5. Once the control valve 30 is opened, gas is expelled and liquid flows through the main line 23, branch lines 22a, 22b and to at least the actuated residential fire sprinkler, which distributes the liquid in a predetermined density over an area to protected from a fire in a compartment of a residential dwelling unit within a predetermined time period elapsing from the actuation of the residential fire sprinkler. The alarm device 38 can also be actuated directly by the sensor 27 or indirectly via the releasing control panel RCP to provide a signal indicative of the actuation of the fire protection system 100.

Referring again to FIG. 3C, an alternate example of the third preferred embodiment of a residential fire protection system will now be described. In particular, the liquid supply source 10 is in fluid communication with the supply control valve 20 via the riser 18. A drain line 16, with a test port fitting 16a, can be coupled in fluid communication with the main pipe 22 with a normally-closed drain valve 19 to drain 19a. The supply control valve 20 is in fluid communication via main pipe 22 with an inlet 30a of the control valve 30 (e.g., an electromagnetically or solenoid actuated valve). Downstream of the control valve 30, a main pipe 23 and a gas pipe 26 is in fluid communication with an outlet 30b of the control valve 30. Preferably, each of the inlet 30a and outlet 30b has an opening with a nominal internal diameter less than two inches. The gas pipe 26 is in fluid communication with a pressurized gas source 28. A check valve 28a can be provided proximate the gas source 28 to prevent influx of liquid into the gas source 28. A relief valve 28b can also be provided downstream of the gas source 28 to prevent over-pressurization of the gas pipe 26. A sensor 27 can be used to detect a change in gas pressure in the branch lines of the piping network. The sensor 27 can be set to one of various threshold pressures, at which threshold value will cause the sensor 27 to provide an output signal 2. The sensor 27 can be configured to provide a signal 2 to a releasing control panel RCP, which determines when to actuate the control valve 30 via signal line 3. A fire detection device 29 that detects the occurrence of smoke, heat or flame 102 (to indicate the occurrence of a fire) is coupled to the releasing control panel via signal line 4. The fire detection device 29 is preferably located such that the device 29 is capable of detecting the fire 102 prior to the actuation of any of the residential fire sprinkler by the fire 102. An alarm 38 is coupled to the RCP via signal line 3. The RCP can be coupled to a remote monitoring station via signal lines 5 or through a suitable communication interface such as, for example, telephone, wireless digital communication or via an internet connection. The RCP can be used to actuate an alarm device 38 or the control valve 20 based on a combination of either the signal 2 from the pressure switch sensor 27 or a fire detection device 29 via signal 4. Alternatively, the RCP can actuate the alarm device 38 and the control valve 20 based on both signals from the sensor 27 and device 29 or one of the signals from the sensor 27 or device 29. A drain 32 with a normally-closed drain valve 34 can also be coupled for fluid communication with the gas pipe 26. Optionally, a control valve 36 can be provided downstream of the gas pipe 26.

In operation of the alternate third preferred embodiment, the supply control valve 20 is placed in a closed position to prevent a flow of liquid to the main pipe 22. Due to its configuration as a normally closed valve, i.e., a valve that occludes flow in the absence of any actuation signal, the control valve 30 occludes water from flowing through the valve 30 to the pipe 23. Gas, on the other hand, is permitted to flow from the gas supply 28 through line 26, main pipe 23, branch lines 22a, and the body of each unactuated residential fire sprinklers. Once a predetermined gas pressure (e.g., 28-34 psig) is reached as indicated by gauge 24, the supply control valve 20 is opened, thereby allowing liquid to flow into the inlet 30a of the control valve 30 but not to main line 23. At this point, the system 100 is in a standby mode because the system 100 is now filled with pressurized gas while liquid is prevented from entering the main line 23.

When gas pressure in the network of pipes is reduced below a threshold value due to fault in the system such as, for example, leaks in the valve, piping or defective fire sprinklers, the system is configured, i.e., “interlocked” to prevent the flow of liquid through the network of pipes, which could cause damage to the compartments of the residential dwelling unit. In particular, the reduction in the gas pressure is detected by sensor 27 and provided to the RCP in the absence of any detection by the fire detection device 29 of a fire. In such case, the control valve 30 is interlocked by a single device (e.g., fire detector 29), i.e., a “single interlock” to prevent the flow of liquid through the network of pipes. Alternatively, the control valve 30 is interlocked by two devices (e.g., fire detector 29 and sensor 27), i.e., a “double-interlock” to prevent the flow of liquid through the network of pipes. In a preferred embodiment, the RCP can be configured or programmed to sound a fault-indication signal with alarm 38 or to provide a signal to the remote monitoring station via signal lines 5 when one or both of the sensor 27 and device 29 are activated.

On the other hand, where the gas pressure in the network of pipes is not below a threshold value to indicate the actuation of a residential fire sprinkler but there is detection of a fire 102 by the fire detection device 29, the RCP can actuate the control valve 30 to provide liquid to the residential fire sprinklers prior to the actuation of any of the sprinklers, i.e., a “pre-action” of the sprinklers. Preferably, the RCP can pre-actuate the system 100 while also providing an indication of a fire 102 through alarm device 38 or to a remote monitoring station.

Alternatively, where both signals from the pressure sensor 27 and the fire detector 29 are provided to the RCP, the RCP can immediately actuate (i.e., “pre-actuate”) the control valve 30 prior to actuation of any of the residential fire sprinklers. Yet in a further alternative, the RCP can delay the actuation of control valve until either or both the sensor 27 and device 29 are activated with supervisory control from a monitoring station via signal lines 5.

Once the control valve 30 is opened, gas can be expelled (via either through relief valve 28b or through an actuated residential fire sprinkler) and liquid flows through the main line 23, branch lines 22a, 22b so as to prefill the body residential fire sprinklers with fire-fighting liquid prior to their actuation. Once actuated, the residential fire sprinkler distributes the liquid in a predetermined density over an area to protected from a fire in a compartment of a residential dwelling unit within a predetermined time period elapsing from the actuation of the residential fire sprinkler.

As installed, suitable residential fire sprinklers described and shown herein can be coupled to a dry piping network, which are supplied with a fire-fighting liquid, e.g., a water supply, after the sprinkler is activated. Preferred embodiments include residential fire sprinklers that are suitable for use such as, for example, with a dry pipe system (e.g. that is the entire system is exposed to freezing temperatures in an unheated portion of a building) or a wet pipe system (e.g. the sprinkler extends into an unheated portion of a building).

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A method of designing a dry pipe residential fire protection system in a residential dwelling unit having a plurality of compartments as defined in the 2002 National Fire Protection Association Standards 13, 13D, and 13R, the method comprising:
determining a minimum quantity and location of residential fire sprinklers required to determine a hydraulic demand calculation of the residential fire sprinklers of a piping network filled with water and arranged to protect the plurality of compartments; and
specifying the minimum quantity and location of residential fire sprinklers, as determined, in a residential fire sprinkler piping network filled with a gas to protect the plurality of compartments.

2. A method of designing a dry pipe residential fire protection system in a residential dwelling unit having a plurality of compartments as defined in the 2002 National Fire Protection Association Standards 13, 13D, and 13R, the method comprising:
determining a minimum quantity of residential fire sprinklers based on a hydraulic demand calculation of all residential fire sprinklers up to four residential fire sprinklers within a compartment of the residential dwelling unit;
specifying the quantity and location of residential fire sprinklers, as determined, in a residential fire sprinkler piping system filled with a gas to protect the plurality of compartments for installation accordance with NFPA 13D and 13R, the residential fire sprinkler system including:
(a) a liquid supply source;
(b) a gas supply source;
(c) a control valve coupled to the liquid and gas supplies, the control valve being biased in a closed position to prevent liquid flow through the control valve based on a pressure differential between the liquid and gas supplies;
(d) a network of pipes coupled to the control valve and the pressurized gas supply, the network of pipes including at least one pipe extending over each of the compartments, the at least one pipe being filled generally with a gas from the pressurized gas supply so that the at least one pipe is dry; and
specifying an indicator of liquid flow through the residential fire sprinkler system.

3. A method of designing a dry pipe residential fire protection system in a residential dwelling unit having a plurality of compartments as defined in the 2002 National Fire Protection Association Standards 13, 13D, and 13R, the method comprising:
determining a minimum quantity of residential fire sprinklers based on a hydraulic demand calculation of all residential fire sprinklers up to four residential fire sprinklers within a compartment of the residential dwelling unit;
specifying the quantity and location of residential fire sprinklers, as determined, in a residential fire sprinkler piping system filled with a gas to protect the plurality of compartments for installation accordance with NFPA 13D and 13R, the system including:
(a) a liquid supply source;
(b) a gas supply source;
(c) a control valve coupled to the liquid supply and configured in a normally closed position to prevent liquid flow through the control valve;
(d) a network of pipes coupled to the control valve and the pressurized gas supply, the network of pipes including at least one pipe extending over each of the compartments, the at least one pipe being filled generally with a gas from the pressurized gas supply so that the at least one pipe is dry;
(e) a releasing control panel to actuate the control valve to an open position that permits liquid to flow through the control valve to the network of pipes and the residential fire sprinklers; and
specifying a device to indicate a reduction in the gas pressure in the network to the releasing control panel.

4. A method of designing a dry pipe residential fire protection system in a residential dwelling unit having a plurality of compartments as defined in the 2002 National Fire Protection Association Standards 13, 13D, and 13R, the method comprising:
determining a minimum quantity of residential fire sprinklers based on a hydraulic demand calculation of all residential fire sprinklers up to four residential fire sprinklers within a compartment of the residential dwelling unit;
specifying the quantity and location of residential fire sprinklers, as determined, in a residential fire sprinkler piping system filled with a gas to protect the plurality of compartments for installation accordance with NFPA 13D and 13R, the system including:
(a) a liquid supply source;
(b) a gas supply source;
(c) a control valve coupled to the liquid supply and configured in a normally closed position to prevent liquid flow through the control valve;
(d) a network of pipes coupled to the control valve and the pressurized gas supply, the network of pipes including at least one pipe extending over each of the compartments, the at least one pipe being filled generally with a gas from the pressurized gas supply so that the at least one pipe is dry;
(e) a releasing control panel to actuate the control valve to an open position that permits liquid to flow through the control valve to the network of pipes and the residential fire sprinklers; and
specifying a device to provide a signal to the releasing control panel that indicates at least one of reduction in gas pressure in the at least one pipe or a fire proximate the dwelling unit.

5. A method of designing a dry pipe residential fire protection system in a residential dwelling unit having a plurality of compartments as defined in the 2002 National Fire Protection Association Standards 13, 13D, and 13R, the method comprising:
determining a quantity of residential fire sprinklers based on a hydraulic demand calculation of all residential fire sprinklers up to four residential fire sprinklers within a compartment of the residential dwelling unit;
specifying the quantity and location of residential fire sprinklers, as determined, in a residential fire sprinkler piping system filled with a gas to protect the plurality of compartments for installation accordance with NFPA 13D and 13R, the system including:
(a) a liquid supply source;
(b) a gas supply source;
(c) a control valve coupled to the liquid supply and configured in a normally closed position to prevent liquid flow through the control valve;
(d) a network of pipes coupled to the control valve and the pressurized gas supply, the network of pipes including at least one pipe extending over each of the compartments, the at least one pipe being filled generally with a gas from the pressurized gas supply so that the at least one pipe is dry;
(e) a pressure sensor coupled to the network of pipes to sense gas pressure in the network of pipes;
(f) a fire detection device disposed proximate the dwelling unit to detect a fire;
(g) an alarm device;
(h) a releasing control panel to actuate the control valve to an open position that permits liquid to flow through the control valve to the network of pipes and the residential fire sprinklers, the releasing control panel being coupled to the alarm device, pressure sensor, and the fire detection device; and
specifying the releasing control panel to activate the alarm to indicate a fault in the system when the pressure sensor senses gas pressure below a threshold value in the absence of a detection of a fire by the fire detection device and activates the alarm and control valve to an open position prior to actuation of the at least one residential fire sprinkler when the fire detection device detects a fire.

6. A method of designing a dry pipe residential fire protection system in a residential dwelling unit having a plurality of compartments as defined in the 2002 National Fire Protection Association Standards 13, 13D, and 13R, the method comprising:
determining a quantity of residential fire sprinklers based on a hydraulic demand calculation of all residential fire sprinklers up to four residential fire sprinklers within a compartment of the residential dwelling unit;
specifying the quantity and location of residential fire sprinklers, as determined, in a residential fire sprinkler piping system filled with a gas to protect the plurality of compartments for installation accordance with NFPA 13D and 13R, the system including:
(a) a liquid supply source;
(b) a gas supply source;
(c) a control valve coupled to the liquid supply and configured in a normally closed position to prevent liquid flow through the control valve;
(d) a network of pipes coupled to the control valve and the pressurized gas supply, the network of pipes including at least one pipe extending over each of the compartments, the at least one pipe being filled generally with a gas from the pressurized gas supply so that the at least one pipe is dry;
(e) a pressure sensor coupled to the network of pipes to sense gas pressure in the network of pipes;
(f) a fire detection device disposed proximate the dwelling unit to detect a fire;
(g) an alarm device;
(h) a releasing control panel to actuate the control valve to an open position that permits liquid to flow through the control valve to the network of pipes and the residential fire sprinklers, the releasing control panel being coupled to the alarm device, pressure sensor, and the fire detection device; and
specifying the releasing control panel to activate the alarm to indicate a fault in the system when the pressure sensor senses gas pressure below a threshold value in the absence of a detection of a fire by the fire detection device and activates the alarm and control valve to an open position upon a receipt of output signals from the fire detection device and pressure sensor.

7. A method of designing a dry pipe residential fire protection system in a residential dwelling unit having a plurality of compartments as defined in the 2002 National Fire Protection Association Standards 13, 13D, and 13R, the method comprising:
specifying a quantity and location of residential fire sprinklers in a residential fire sprinkler piping network filled with a gas to protect the plurality of compartments; and
specifying at least one component of the dry pipe residential fire sprinkler piping network as a fire-resistant plastic component.

8. A method of designing a dry pipe residential fire protection system in a residential dwelling unit having a plurality of compartments as defined in the 2002 National Fire Protection Association Standards 13, 13D, and 13R, the method comprising:
specifying a quantity and location of residential fire sprinklers in a residential fire sprinkler piping network having a main pipe filled with liquid and a branch pipe connected to the residential fire sprinklers filled with a gas to protect the plurality of compartments; and
specifying the branch pipe as a fire-resistant plastic branch pipe with an opening having a cross-sectional area different than the cross-sectional area of the main pipe.
